(19) United States
(12) Patent Application Publication
(10) Pub. No.: US 2026/0032260 A1
(43) Pub. Date: Jan. 29, 2026

(54) ENCODING/DECODING METHOD, CODE STREAM, ENCODER, DECODER AND STORAGE MEDIUM

(71) Applicant: GUANGDONG OPPO MOBILE TELECOMMUNICATIONS CORP., LTD., Dongguan (CN)

(72) Inventor: Fan WANG, Dongguan (CN)

(21) Appl. No.: 19/342,990

(22) Filed: Sep. 29, 2025

Related U.S. Application Data
(63) Continuation of application No. PCT/CN2023/085870, filed on Apr. 3, 2023.

(51) Int. Cl. H04N 19/159; H04N 19/176; H04N 19/196

(52) U.S. Cl. CPC H04N 19/159; H04N 19/176; H04N 19/196

(57) ABSTRACT

An encoding method, a decoding method and a storage medium are provided. The method includes: if a prediction mode corresponding to the current block is a preset prediction mode, according to size information of the current block, determining a first template corresponding to the current block from among at least one candidate template, wherein the preset prediction mode includes a template-based prediction mode; and according to the first template, determining a predicted value corresponding to the current block.

### CROSS-REFERENCE TO RELATED APPLICATION

This application is a continuation of International Patent Application No. PCT/CN2023/085870 filed on Apr. 3, 2023, the content of which is hereby incorporated by reference in its entirety.

### BACKGROUND

In some prediction processing procedures for picture information, prediction of a coding block can be performed by using the template matching technology or the template analysis technology. Prediction technologies involving the use of templates may be collectively referred to as template-based prediction technologies.

In the related art, the template-based prediction technologies include, but are not limited to, inter template matching, template matching for Intra Block Copy (IBC), Intra Template Matching Prediction (Intra TMP), Template based intra mode derivation (TIMD), and Decoder-side Intra Mode Derivation (DIMD), etc.

However, in the practical application of template-based prediction technologies, some templates are not applicable in some scenarios, such as the cases where there is a significant difference between the width and height, or where the number of template samples on one side is too small. The use of some templates may increase unnecessary overhead or amplify interference caused by unreasonable results.

### SUMMARY

Embodiments of the present disclosure relate to the field of video coding technology, and in particular to an encoding and decoding method, and a storage medium.

The technical solutions of the embodiments of the present disclosure can be implemented as follows.

In a first aspect, the embodiments of the present disclosure provide a decoding method. The method is applied to a decoder and includes the following operations.

When a prediction mode corresponding to a current block is a preset prediction mode, a first template corresponding to the current block is determined from at least one candidate template according to size information of the current block. The preset prediction mode includes a template-based prediction mode.

A prediction value corresponding to the current block is determined according to the first template.

In a second aspect, the embodiments of the present disclosure provide an encoding method. The method is applied to an encoder and includes the following operations.

When a prediction mode corresponding to a current block is a preset prediction mode, a first template corresponding to the current block is determined from at least one candidate template according to size information of the current block. The preset prediction mode includes a template-based prediction mode.

A prediction value corresponding to the current block is determined according to the first template.

In a third aspect, an embodiment of the present disclosure provides a non-transitory computer-readable storage medium, having a computer program and a bitstream stored thereon. The computer program, when executed by a processor, enables the processor to perform operations of the encoding method in the second aspect to generate the bitstream.

### BRIEF DESCRIPTION OF THE DRAWINGS

FIG. 1 is a diagram of a basic flow of a video codec.

FIG. 2 is a diagram of a positional relationship between a current block and reference samples.

FIG. 3 is a diagram of using 4 reference rows/columns in an intra prediction method.

FIG. 4 is a diagram of 9 modes for intra prediction of a 4×4 block in H.264.

FIG. 5 is a diagram of 35 intra prediction modes used in High Efficiency Video Coding (HEVC).

FIG. 6 is a diagram of 67 intra prediction modes used in Versatile Video Coding (VVC).

FIG. 7 is a diagram of a wide-angle mode.

FIG. 8 is a diagram of 66 prediction modes used in Audio Video Coding Standard 3 (AVS3).

FIG. 9 is a diagram of screen content.

FIG. 10 is a diagram of inter prediction.

FIG. 11 is a diagram of intra TMP.

FIG. 12 is a diagram of Matrix-based Intra prediction (MIP).

FIG. 13 is a diagram of TIMD.

FIG. 14 is a diagram of DIMD.

FIG. 15 is a diagram of weights for different intra prediction modes.

FIG. 16 is a first diagram of template types.

FIG. 17 is a block diagram of a composition of an encoder.

FIG. 18 is a block diagram of a composition of a decoder.

FIG. 19 is a diagram of a network architecture of a codec system.

FIG. 20 is a flowchart of a decoding method according to an embodiment of the present disclosure.

FIG. 21 is a second diagram of template types.

FIG. 22 is a diagram of candidate templates.

FIG. 23 is a flowchart of an encoding method according to an embodiment of the present disclosure.

FIG. 24 is a structural diagram of an encoder.

FIG. 25 is a diagram of a hardware structure of an encoder.

FIG. 26 is a structural diagram of a decoder.

FIG. 27 is a diagram of a hardware structure of a decoder.

FIG. 28 is a structural diagram of a codec system.

### DETAILED DESCRIPTION

In order to enable a more detailed understanding of the features and technical contents of the embodiments of the present disclosure, implementations of the embodiments of the present disclosure will be described in detail below with reference to the accompanying drawings. The accompanying drawings are provided solely for purposes of reference and illustration and are not intended to limit the embodiments of the present disclosure.

Unless otherwise defined, all technical and scientific terms used herein have the same meaning as commonly understood by those skilled in the technical field of the present disclosure. The terms used herein are only for the purpose of describing the embodiments of the present disclosure, and are not intended to limit the present disclosure.

In the following description, reference is made to “some embodiments”, which describe a subset of all possible embodiments. However, it can be understood that “some embodiments” may refer to the same subset or different subsets of all possible embodiments, and may be combined with each other without conflict. It should be noted that the terms “first\second\third” involved in embodiments of the present disclosure are used to distinguish similar objects and do not represent a specific order. It can be understood that such used “first\ second\ third” may be interchanged in specific order or sequence where permitted, so that the embodiments of the present disclosure described herein may be implemented in an order other than those illustrated or described herein.

Before further detailing the embodiments of the present disclosure, the nouns and terms involved in the embodiments of the present disclosure are explained. The nouns and terms involved in the embodiments of the present disclosure are applicable to the following explanations:
Coding Block (CB);
Block Matching (BM);
Coding Unit (CU);
Block Vector (BV);
Sum of Absolute Difference (SAD);
Sum of Absolute Transformed Difference (SATD);
Mean Square Error (MSE);
Sum of Squared Differences (SSD);
Mean Absolute Deviation (MAD);
Mean Square Differences (MSD);
Normalized Correlation Coefficient (NCC);
H.266/Versatile Video Coding (VVC);
VVC Test Model (VTM);
Intra Template Matching Prediction (Intra TMP);
Beyond VVC reference software test platform (Enhanced Compression Model, ECM);
Matrix-based Intra prediction (MIP);
Template based intra mode derivation (TIMD);
Decoder-side Intra Mode Derivation (DIMD).

It may be understood that in a video picture, the first colour component, the second colour component and the third colour component are generally used to represent a coding block. These three colour components are a luma component, a blue chroma component, and a red chroma component, respectively. Specifically, the luma component is usually denoted by the symbol Y, the blue chroma component is usually denoted by the symbol Cb or U, and the red chroma component is usually denoted by the symbol Cr or V. Thus, the video picture may be represented in the YCbCr format or the YUV format.

Most video coding standards adopt a block-based hybrid coding framework. Each picture, sub-picture, or frame in a video is partitioned into square Largest Coding Units (LCUs) or Coding Tree Units (CTUs) of the same size (for example, 128×128 or 64×64, etc.). Each LCU or CTU may be partitioned into rectangular Coding Units (CUs) according to rules. A Coding Unit may be further partitioned into Prediction Units (PUs) and/or Transform Units (TUs), etc. The hybrid coding framework includes modules such as prediction, transform, quantization, entropy coding, and in-loop filtering. The prediction module includes intra prediction and inter prediction. The inter prediction includes motion estimation and motion compensation. Due to the strong correlation between neighbouring samples within a frame of a video, intra prediction methods are used in the video coding technology to eliminate spatial redundancy between neighbouring samples. Due to the strong similarity between neighbouring frames of the video, inter prediction methods are used in video coding technology to eliminate temporal redundancy between neighbouring frames, thereby improving the coding efficiency.

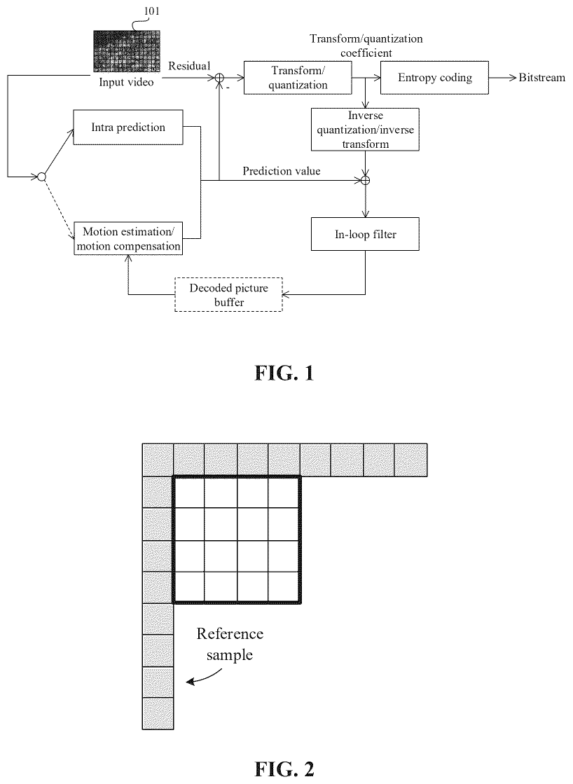

FIG. 1 illustrates a basic flow of a video codec. At the encoder side, a frame of picture 101 is partitioned into blocks. Intra prediction or inter prediction is performed on the current block to generate a prediction block for the current block. The residual block is obtained by subtracting the prediction block from the original block of the current block. The residual block is transformed and quantized to obtain a quantized coefficient matrix. The quantized coefficient matrix is entropy-encoded and output to the bitstream. At the decoding side (not illustrated in the figure), the intra prediction or inter prediction is performed on the current block to generate the prediction block for the current block. On the other hand, the bitstream is parsed to obtain the quantized coefficient matrix. The quantized coefficient matrix is inverse-quantized and inverse-transformed to obtain the residual block. The prediction block and the residual block are added to obtain a reconstructed block. Reconstructed blocks form a reconstructed picture. Loop filtering is performed on the reconstructed picture based on the picture or based on the block to obtain a decoded picture. The encoding side also needs to perform operations similar to those of the decoding side to obtain the decoded picture. At the encoding side, the obtained decoded picture may serve as a reference picture for inter prediction for subsequent frames. Block partitioning information determined by the encoding side, as well as mode information or parameter information such as prediction, transform, quantization, entropy encoding, and in-loop filtering, if necessary, need to be signalled in the output bitstream. The decoding side determines the block partitioning information, as well as mode information or parameter information such as prediction, transform, quantization, entropy encoding, loop filtering, which are the same as those of the encoding side, by parsing and analyzing based on existing information, thereby ensuring that the decoded picture obtained by the encoding side is the same as the decoded picture obtained by the decoder side. The decoded picture obtained by the encoding side is usually also referred to as a reconstructed picture. During the prediction, the current block may be partitioned into prediction units, and during the transform, the current block may be partitioned into transform units. The partitioning of prediction units and transform units may be different.

The above is the basic flow of a video codec under the block-based hybrid coding framework. With the development of technology, some modules or operations of the framework or flow may be optimized. The encoding and decoding methods provided by the embodiments of the present disclosure are applicable to the basic flow of the video codec under the block-based hybrid coding framework but are not limited to the framework and flow. Those of ordinary skill in the art will understand that with the evolution of encoders and decoders and the emergence of new service scenarios, the methods provided by the embodiments of the present disclosure are equally applicable to similar technical problems.

A current block may be a current Coding Unit (CU) or a current Prediction Unit (PU), etc.

It may be understood that there is a strong spatial correlation between neighbouring parts or neighbouring samples within a picture. The intra prediction is a method that utilizes the spatial correlation between already encoded/decoded samples around the current block and the samples inside the current block for prediction. For example, as illustrated in FIG. 2, the white 4×4 block is the current block, and the gray samples in the left column and the above row of the current block are reference samples of the current block. For the intra prediction, these reference samples are used to predict the current block. These reference samples may all be available, that is, they have all been encoded/decoded. Alternatively, some reference samples may be unavailable. For instance, if the current block is at the far left of the entire frame, the reference samples on the left of the current block are unavailable. Alternatively, when encoding/decoding the current block, if the lower-left part of the current block has not yet been encoded/decoded, the lower-left reference samples are also unavailable. For the cases where the reference samples are unavailable, available reference samples, certain values, or certain methods may be used for padding, or padding may be omitted.

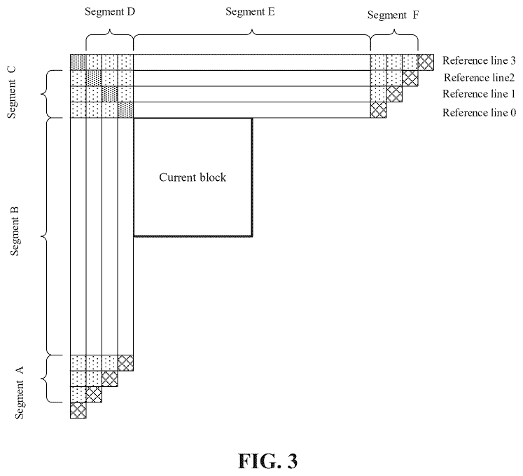

In the Multiple Reference Line (MRL) intra prediction method, more reference samples may be used, thereby improving the coding efficiency. FIG. 3 illustrates an example of using 4 reference rows/columns.

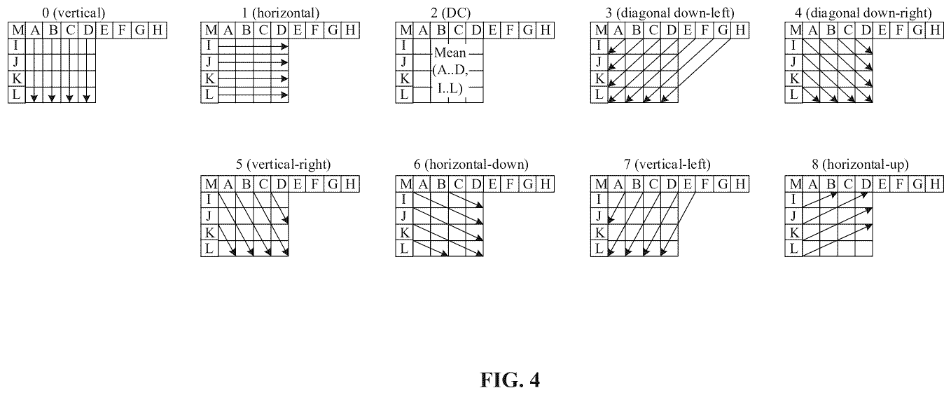

There are multiple intra prediction modes. FIG. 4 illustrates 9 modes for the intra prediction of a 4×4 block in H.264. For mode 0, the samples above the current block are copied vertically into the current block as the prediction values. For mode 1, the reference samples to the left are copied horizontally into the current block as the prediction values. For mode 2 (i.e., DC mode), the average of the 8 points A˜D and I˜L is taken as the prediction value for all points. For modes 3˜8, the reference samples are copied into the corresponding positions in the current block at certain angles (thus the modes 3˜8 are also referred to as angular prediction modes). Because some positions in the current block may not exactly correspond to the reference samples, the weighted averages of the reference samples (or in other words, interpolated sub-samples (sub-pixels) of the reference samples) may need to be used.

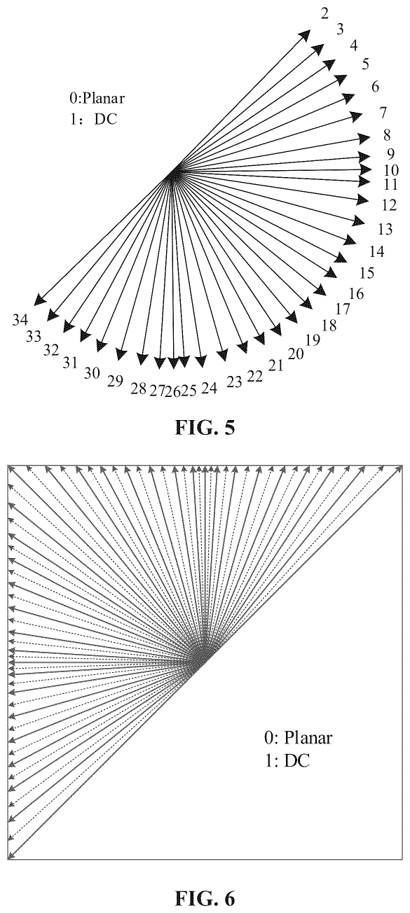

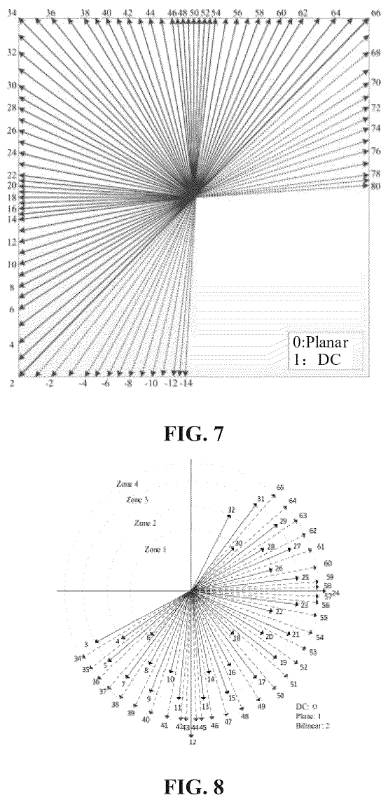

In addition, there are modes such as Plane, Planar, and the like. The number of angular prediction modes increases with the development of technology and the expansion of blocks. As illustrated in FIG. 5, HEVC uses 35 intra prediction modes, which include Planar, DC, and 33 angular modes. As illustrated in FIG. 6, VVC uses 67 intra modes, which include Planar, DC, and 65 angular modes. Of course, besides these 67 modes, VVC also provides wide-angle modes for rectangular blocks with significant differences in length and width, such as the modes indicated by the dashed lines in FIG. 7 in the two intervals −14˜−1 and 67˜80, which replace some conventional modes. As illustrated in FIG. 8, AVS3 adopts 66 prediction modes, which include DC, Plane, Bilinear, PCM, and 62 angular modes.

A video consists of multiple pictures. To make the video appear smooth, each second of video contains dozens or even hundreds of frames of pictures, such as 24 frames per second, 30 frames per second, 50 frames per second, 60 frames per second, or 120 frames per second, etc. Thus, there is very significant temporal redundancy in the video. In other words, there is considerable temporal correlation in the video. In the inter prediction, this temporal correlation is used to improve the compression efficiency. In the inter prediction, “motion” is commonly used to exploit the temporal correlation. A very simple “motion” model is that an object is at a certain position in the picture at one moment, and after a certain time, in the picture corresponding to that moment, it moves to another position. This is the basic and commonly used translational motion in the video coding. For the inter prediction, motion information is used to represent “motion”. Basic motion information includes information of the reference frame (or reference picture) and information of the Motion Vector (MV) information. The codec determines the reference picture based on the information of the reference picture, and determines the coordinates of the reference block based on the motion vector information and the coordinates of the current block. The coordinates of the reference block in the reference picture are used to determine the reference block. Taking the determined reference block as the prediction block is the most basic prediction method for the inter prediction.

Motion in the video is not always simple. Even the motion that is considered as translational may have subtle changes over time, including slight deformation, brightness changes, and noise changes, etc. More than one reference block may be used for the prediction of the current block to achieve better prediction results. For example, for the bi-prediction, two reference blocks are used to predict the current block. The two reference blocks may be one forward reference block and one backward reference block. It is also allowed that the two reference blocks are both forward or both backward. The expression “forward” means that the moment corresponding to the reference picture is before the current frame, and the expression “backward” means that the moment corresponding to the reference picture is after the current frame. In other words, the expression “forward” means that the position of the reference picture in the video is before the current frame, and the expression “backward” means that the position of the reference picture in the video is after the current frame. In other words, the expression “forward” means that the Picture Order Count (POC) of the reference picture is less than the POC of the current frame, and the expression “backward” means that the POC of the reference picture is greater than the POC of the current frame. Future video coding standards may support the prediction using multiple reference blocks. A simple method to generate a prediction block using two reference blocks is to average the pixel values at corresponding positions of the two reference blocks to obtain the prediction block. In order to obtain better prediction performance, the weighted averaging may also be used, such as Bi-prediction with CU-level weight (BCW) used in VVC. Geometric partitioning mode (GPM) in VVC may also be understood as a special type of bi-prediction. In order to use bi-prediction, naturally, two reference blocks need to be found, which requires two sets of reference picture information and motion vector information.

Motion in the video not only includes the simple translation but also includes scaling, rotation, warping deformation, and various complex motions. VVC uses affine models to simulate some of these simple motions. The affine model in VVC uses two or three control points. Based on these control points, a linear model is used to derive the motion vector for each sub-block within the current block. The reason why the wording is motion vector here rather than motion information is that they all point to the same reference picture. It can be understood that for the ordinary translational motion, a “whole block” is found from the reference picture, while for the affine model, a set of “sub-blocks” that are not adjacent to each other is found from the reference picture. The above contents belong to the category of unidirectional prediction. The affine model can also achieve bi-prediction or prediction with more “reference blocks”. The reference blocks mentioned here are composed of sub-blocks. In specific implementation, one piece of unidirectional motion information in the data structure of the affine motion information may include the information of one reference picture and the information of two to three motion vectors, or may include the information of two to three sets of reference pictures and the information of the motion vector. The information of these reference pictures is the same.

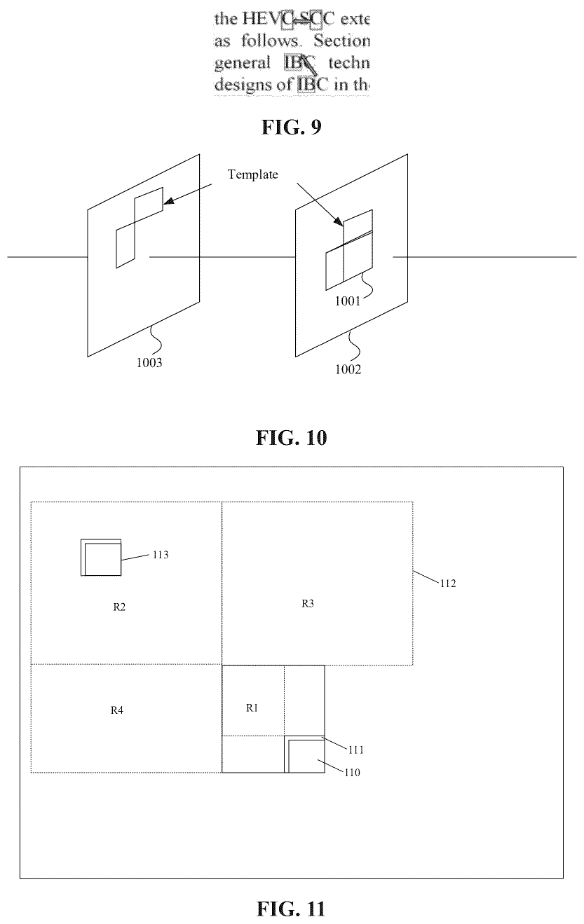

Intra Block Copy (IBC) can significantly improve the compression efficiency of screen content coding (SCC). Therefore, IBC is used for screen content coding from HEVC to VVC. The screen content is different from camera captured content, and is generated by the computer. The screen content has no noise, contains text and computer graphics, etc., and has sharp boundaries. The screen content contains a large amount of repeated content. As illustrated in FIG. 9, the contents in the two boxes in the first row are repeated, and the content within the box in the third row and the content in the box in the fourth row are repeated.

As mentioned above, for the inter prediction, a reference block from a reference picture is taken as the prediction block for the current block. The reference picture is not the current picture. For the IBC, a block is found from the already encoded/decoded part (which is referred to as the reconstructed part) of the current picture to serve as the prediction block for the current block. The IBC is also referred to as intra picture block compensation or current picture referencing (CPR). The name of IBC is not limited in the embodiments, and the aforementioned names may be used equally or interchangeably without special explanation.

For the IBC, a Block Vector (BV) is used to represent the positional difference between the current block and the reference block. The encoder determines the best matching block for the current block through block matching within a search range and encodes the BV. There are various methods for encoding the BV, which will not be detailed here. The IBC may be considered as an intra prediction method or may be considered as another type of prediction method independent of the intra prediction and the inter prediction.

The Template Matching (TM) method was first used in the inter prediction. This method uses the correlation between neighbouring samples and takes some regions around the current block as the templates. When the current block is encoded/decoded, blocks on the left and above sides have already been encoded/decoded according to the coding order. Of course, in the implementation of the hardware decoder, it may not be ensured that the blocks on the left and above sides have been decoded when starting to decode the current block. Of course, the inter block is discussed here. For example, in the HEVC, when generating the prediction block for the inter-encoded block, the neighbouring reconstructed samples are not required, so that the prediction process for the inter block may be performed in parallel. However, for the intra-encoded block, the reconstructed samples on the left and above sides are required to serve as the reference samples. Theoretically, the reference samples on the left and upper sides of the current block are available. In other words, the corresponding adjustments of the hardware design can be achieved. Relatively speaking, the reference samples on the right and bottom sides of the current block are unavailable under the encoding order of the video standards like VVC.

As illustrated in FIG. 10, the rectangular regions on the left and above sides of the current block 1001 are set as the templates. The height of the left template part is generally the same as the height of the current block 1001, and the width of the above template part is generally the same as the width of the current block 1001, though they may also be different. The best matching position for the template is searched for in the reference frame 1003 of the current frame 1002 to determine the motion information or motion vector of the current block 1001. This process may be roughly described as starting from a starting position in a certain reference frame and performing the search within a certain neighbouring range. Search rules (e.g., search range and search step size) may be preset. Each time it moves to a position, the matching degree between the template corresponding to that position and the templates neighbouring the current block is calculated. The matching degree may be measured by some distortion cost, such as Sum of Absolute Difference (SAD), Sum of Absolute Transformed Difference (SATD), or Mean-Square Error (MSE), etc. A smaller value of SAD, SATD, or MSE indicates a higher matching degree. The transform used in the SATD may be a Hadamard transform. The cost may be calculated by using the prediction block of the template corresponding to that position and the reconstructed blocks of the templates neighbouring the current block. In addition to searching at the integer pixel positions, searching at the fractional pixel positions may also be performed. The motion information of the current block may be determined based on the searched position with the highest matching degree. By using the correlation between neighbouring samples, it can be inferred that suitable motion information for the template may also be applicable to the current block. Of course, the template matching method may not be applicable to all blocks, so some methods may be used to determine whether the current block uses the aforementioned template matching method. For example, a control switch may be used in the current block to indicate whether to use the template matching method. Template matching technology is, for example, Decoder-side motion Vector Derivation (DMVD). Both the encoder and the decoder can use the template for search to derive the motion information or find better motion information based on the original motion information, and specific motion vectors or motion vector differences are not required to be transmitted. Both the encoder and decoder can perform the search according to the same rules, so that the consistency between encoding and decoding can be ensured. The template matching method can improve the compression performance; however, it requires the “search” to be performed in the decoder as well, which introduces certain complexity in the decoder.

Intra Template Matching Prediction (Intra TMP) is also a kind of prediction technology. As mentioned above, the overhead of encoding the MV can be reduced by the TM. That is, the overhead of encoding the BV can be reduced by the TM. One example is that there is no need to encode the BV, and the matching block found by the TM is directly taken as the prediction block for the current block in the intra TMP mode.

An example of the intra TMP is illustrated in FIG. 11. The inverted L-shaped region 111 on the above-left of the current block 110 is taken as the template, and a search is performed within the search range 112. The search range is the already reconstructed region. The illustrated region 112 includes current CTU (R1), above-left CTU (R2), above CTU (R3), and left CTU (R4). This is an example, and the actual search range may vary. In the example in FIG. 11, the best matching block 113 is found in R2.

As introduced above, an important reason why the IBC can significantly improve the compression efficiency of the screen content coding is that many repeated blocks can be found in the screen content. The screen content usually has sharp boundaries, and in terms of colour (luma and chroma), there will be large regions with the same colour (luma and chroma). The content captured by a camera also has approximately repeated blocks. Even considering the impacts of factors such as noise, subtle changes in brightness, and perspective angles, it is undeniable that repeated textures exist in the content captured by the camera.

In the Intra TMP, the best matching block found through the template matching is taken as the finally determined prediction block. That is, in the related art, when decoding the current block, there is a flag for determining whether the intra TMP is used for the current block. When the intra TMP is used for the current block, the decoder will use the template matching method to find a best matching block and take the value of the best matching block as the prediction value for the current block. It can be understood that although the template has a strong correlation with the current block, the template is, after all, not the current block. The best matching block (actually the position of the current block corresponding to the best matching block of the template) found through the template may not necessarily be the best matching block of the current block. However, the current block does not exist when the decoder performs the search, so it can only use the best matching block found through the template as the best matching block found through the intra TMP.

To further improve prediction accuracy, an intra TMP multi-candidate method may be adopted. Specifically, the intra TMP may use the template matching to build a candidate list. Compared to directly determining the best matching block found through the template matching, more choices may be provided for the encoder by building the candidate list. In some cases, especially for the content captured by the camera, it is difficult to find a perfect matching block. Template matching is used to filter a large number of possible BVs to select a few candidates with high matching degrees, and then the encoder decides which candidate to choose, which helps improve the compression efficiency.

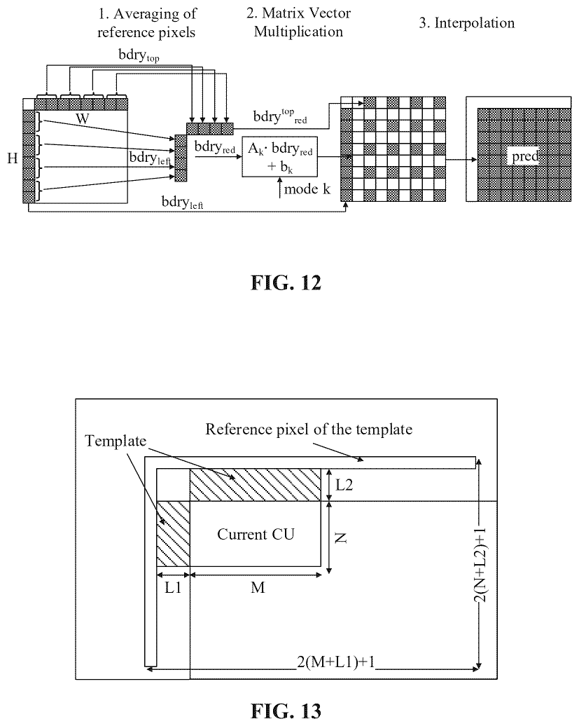

Matrix Weighted Intra prediction (MIP) is a special intra prediction mode. FIG. 12 is a diagram of MIP. As illustrated in FIG. 12, in order to predict a block of width W and height H, in the MIP, the H reconstructed samples in the left column and the W reconstructed samples in the above row of the current block are required to be input. In the MIP, a prediction block is generated by the following three operations: averaging of the reference samples, matrix-vector multiplication, and interpolation. The matrix-vector multiplication may be considered as the core of the MIP. That is, the MIP may be considered a process of generating the prediction block through the matrix-vector multiplication method by using the input samples (reference samples).

The MIP provides multiple matrices. The difference in prediction methods is reflected in the different matrices. Different results will be obtained when the same input samples are processed using different matrices. The processes of the averaging and interpolation of the reference sample are designs that balance the performance and complexity. For large blocks, the averaging of the reference samples can achieve an effect similar to the downsampling, which allows the input to adapt to small matrices, while the interpolation achieves an upsampling effect. In this way, there is no need to provide MIP matrices for blocks of every size; instead, it is sufficient to provide matrices of only one or several specific sizes.

With the increasing demand for the compression performance and the improvements in hardware capabilities, more complex MIP may appear in the next generation of standard.

The MIP is somewhat similar to planar mode. However, it is obvious that the MIP is more complex and flexible than planar.

The TIMD uses the templates to analyze and filter intra prediction modes. The MV or BV in the “search” space used in the inter prediction or IBC is not used, but the intra prediction mode is “searched” from another perspective. Therefore, it does not involve the templates neighbouring the current block and reconstructed samples other than the reference samples of the template.

FIG. 13 is a diagram of the TIMD. As illustrated in FIG. 13, for the current block, regions on the left and above sides of the current block are used as the templates. Except for the boundary cases, theoretically, the reconstructed values can be obtained for the left and above sides of the current block when encoding/decoding the current block. This is the basis for many template matching methods. The TIMD takes the regions marked as Templates in the figure as the templates, and the region marked as Reference of the template is the reference samples of the template. The decoder can use a certain intra prediction mode to perform prediction on the template and compare the prediction values with the reconstructed values to obtain the costs of the intra prediction mode on the templates, such as SAD, SATD, SSE, etc. Since the templates are neighbouring to the current block and they are correlated, the performance of a prediction mode on the template may be used to estimate its performance on the current block. In the TIMD, some candidate intra prediction modes are used for prediction on the templates to obtain their costs on the templates, and the one or two intra prediction modes with the lowest cost are selected as the intra prediction values of the current block.

It should be noted that when the cost difference between two intra prediction modes on the template is small, the compression performance can be improved by performing weighted averaging on the prediction values of the two intra prediction modes. The weights of the prediction values of the two prediction modes are related to the aforementioned costs. For example, the weight may be set to be inversely proportional to the cost.

In other words, the TIMD uses the prediction performance of the intra prediction modes on the templates to filter intra prediction modes, and two intra prediction modes may be weighted according to their costs on the templates. The two intra prediction modes may also be extended to multiple modes in later technological evolution. The advantage of the TIMD is that if the TIMD mode is selected for the current block, it is not necessary to indicate which specific intra prediction mode is used, and the decoder derives it through the above processes, thereby saving the overhead to some extent.

In the DIMD, the reconstructed samples on the left and above sides of the current block are used to derive the prediction mode. However, the prediction is not performed on the templates; instead, the gradients of the reconstructed samples are analyzed.

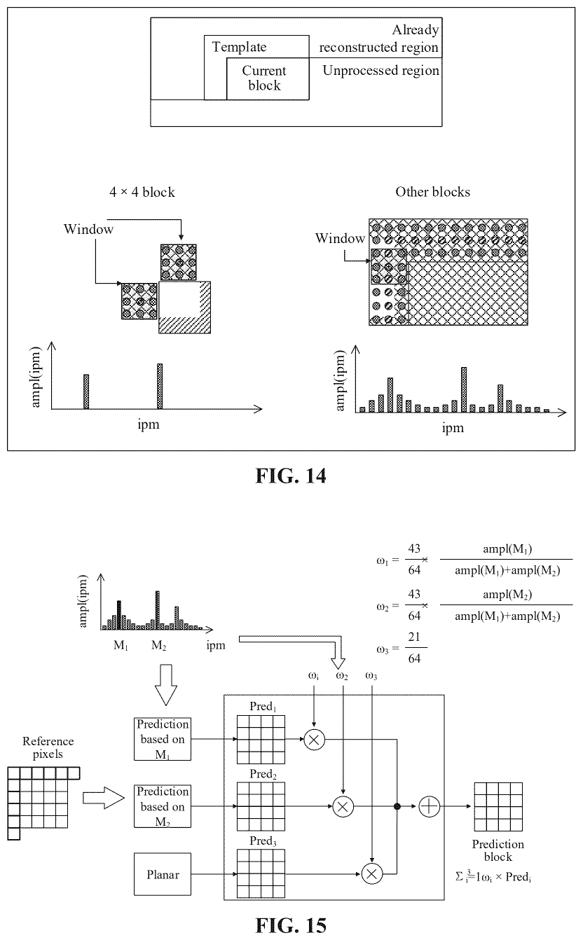

FIG. 14 is a diagram of the DIMD. As illustrated in FIG. 14, in the DIMD, the gradient of the dark points is analyzed and an intra prediction mode is adopted based on its gradient. A result similar to the histogram below can be obtained by analyzing all points that need to be checked. Of course, the histogram is just for understanding, and various simple forms may be used in specific implementation. In the current DIMD, the two intra prediction modes with the highest values in the histogram are selected. The prediction values of three intra prediction modes, i.e., these two intra prediction modes and the planar mode, are weighted. The weights are related to the analysis results.

Exemplarily, FIG. 15 is a diagram of weights of different intra prediction modes. As illustrated in FIG. 15, in the DIMD, the two intra prediction modes with the highest values in the histogram (e.g., M1 and M2) are selected. The corresponding weights @1, @2, @3 for the three intra prediction modes (i.e., M1, M2 and the planar mode) may be determined with reference to the analysis result of the dark points. Finally, the weighted prediction is performed on the prediction values of these three intra prediction modes to obtain the prediction value.

That is, in the DIMD, the gradient of reconstructed samples is analyzed to filter intra prediction modes, and two intra prediction modes and the planar mode are weighted based on the analysis result. The advantage of the DIMD is that if the DIMD mode is selected for the current block, it is not necessary to indicate which specific intra prediction mode is used, and the decoder derives it through the above processes, thereby saving the overhead to some extent. The two intra prediction modes may also be extended to multiple modes in later technological evolution.

The TIMD and DIMD have many similarities. Even in previous literature, their names were sometimes reversed. They both support weighting the prediction values of two or more intra prediction modes. On the other hand, although the prediction on the template is not performed in the DIMD, the regions of the templates are used. For convenience of description later, the DIMD may also be classified as a template-based prediction technology.

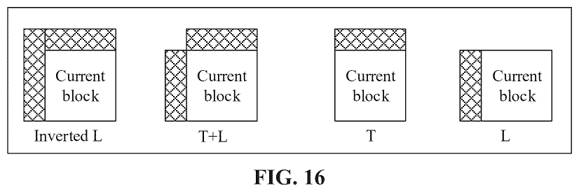

When performing the intra TMP, FIG. 16 is a first diagram of template types. As illustrated in FIG. 16, the templates currently used for the intra TMP in the ECM are an inverted L-shaped template including a left neighbouring reconstructed sample, an above neighbouring reconstructed sample and an above-left neighbouring reconstructed sample. In some other technologies using the template matching, the above-left neighbouring sample may not be used in some templates.

Besides the complete template, a part of the regions of templates may also be used as the template, such as the above template and the left template illustrated in FIG. 16. For convenience of expression here, the complete template (inverted L or T+L) is collectively referred to as the TL template, the above template is referred to as the T template, and the left template is referred to as the L template. More choices may be provided by multiple different templates. Template matching uses the template to estimate the current block, and it is assumed that a block with high template matching degree also has high matching degree for the current block. However, video contents are diverse, especially pictures captured by a camera. Assuming that the texture changes on the left and right sides near the left edge of the current block, using only the T template might be more appropriate than the TL template. Similarly, assuming that the texture changes on the above and bottom sides near the top edge of the current block, using only the L template might be more appropriate than the TL template. Thus, technologies utilizing the template analysis may also use multiple different templates to provide more choices.

Of course, the templates may also include above-right reconstructed samples, bottom-left reconstructed samples, etc. For example, the T template extends further to the right beyond the part illustrated in the figure, and the L template extends further downward beyond the part illustrated in the figure. Alternatively, besides the T template and L template, an above-right template, a bottom-left template, etc., may be added.

It should be noted that technologies requiring the use of templates, such as template matching technology and template analysis technology, may be collectively referred to as the template-based prediction technologies. The template-based prediction technologies may include, but are not limited to, inter template matching (inter template matching prediction), IBC template matching, intra TMP, TIMD, DIMD, etc.

For example, the intra TMP may use the TL template, the T template, and the L template respectively for the template matching to determine the BV. The inter template matching technology may use the TL template, the T template, and the L template respectively for the template matching to determine the MV. The TIMD may use the TL template, the T template, and the L template respectively to derive the intra prediction mode. The DIMD may use the TL template, the T template, and the L template respectively to derive the intra prediction mode.

It may be understood that for common template-based prediction technologies, some templates are not applicable to all scenarios. For example, the T template and the L template can provide more choices but are not applicable to all situations. Considering the cases where there is a significant difference in the width and the height or where the number of template pixels on one side is too small, the use of the T template and/or L template can be restricted, thereby reducing unnecessary overhead or reducing interference caused by unreasonable results.

The embodiments of the present disclosure provide encoding and decoding methods, a bitstream, an encoder, a decoder, and a storage medium. When a prediction mode corresponding to a current block is a preset prediction mode, a first template corresponding to the current block is determined from at least one candidate template according to size information of the current block. The preset prediction mode includes a template-based prediction mode. A prediction value corresponding to the current block is determined according to the first template. It can be seen that in the embodiments of the present disclosure, when the preset prediction mode, which is a template-based prediction mode, is used for prediction processing on the current block, the at least one candidate template may be determined according to the size information of the current block. The use of candidate templates that do not conform to the size information of the current block is restricted to obtain the first template used in the subsequent prediction processing. Since the first template is obtained based on the size information of the current block, during the prediction processing by using the template-based prediction mode, the first template can be suitable for the scenario corresponding to the current block, which can reduce unnecessary overhead or interference caused by unreasonable results, thereby improving the compression efficiency and the encoding and decoding performance.

Hereinafter, embodiments of the present disclosure will be described in detail with reference to the accompanying drawings.

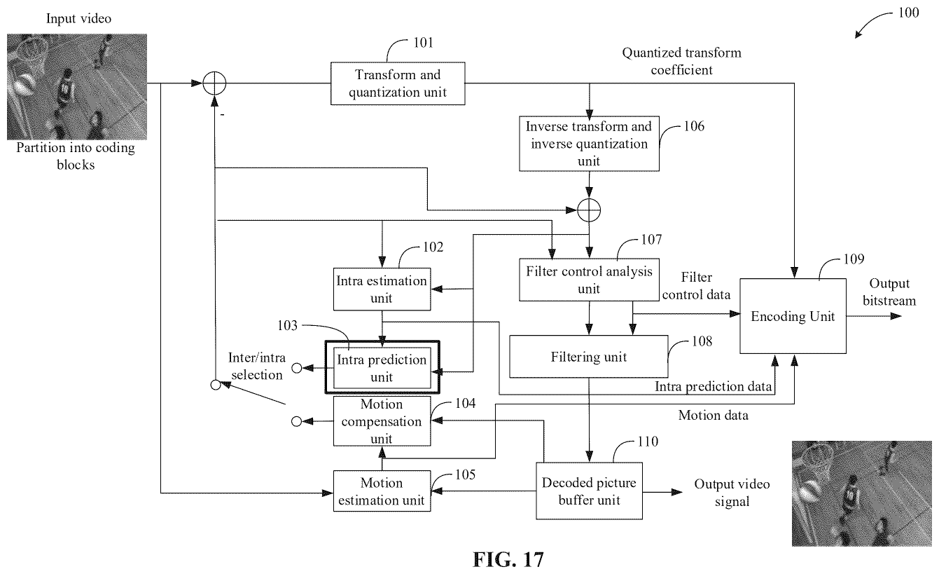

Referring to FIG. 17, a block diagram of a composition of an encoder according to an embodiment of the present disclosure is illustrated. As illustrated in FIG. 17, the encoder (specifically, a “video encoder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, an encoding unit 109, a decoded picture buffer unit 110, and the like. The filtering unit 108 may implement de-block filtering and Sample Adaptive Offset (SAO) filtering. The encoding unit 109 may implement header information encoding and Context-based Adaptive Binary Arithmetic Coding. For the input original video signal, a video coding block may be obtained by partitioning a Coding Tree Unit (CTU). Then the residual pixel information of the video coding block, obtained after the intra or inter prediction is transformed by the transform and quantization unit 101, which includes transforming the residual information from the pixel domain to the transform domain, and quantizing the obtained transform coefficient to further reduce the bit rate. The intra estimation unit 102 and the intra prediction unit 103 are used to perform intra prediction on the video coding block. Specifically, the intra estimation unit 102 and the intra prediction unit 103 are used to determine an intra prediction mode to be used to encode the video coding block. The motion compensation unit 104 and the motion estimation unit 105 are used to perform the inter prediction coding of the received video coded block with respect to one or more blocks in the one or more reference frames to provide the temporal prediction information. The motion estimation performed by the motion estimation unit 105 is a process of generating a motion vector that can estimate the motion of the video coding block, and then the motion compensation unit 104 performs motion the compensation based on the motion vector determined by the motion estimation unit 105. After determining the intra prediction mode, the intra prediction unit 103 is further configured to supply the selected intra prediction data to the encoding unit 109, and the motion estimation unit 105 also sends the calculated motion vector data to the encoding unit 109. Further, the inverse transform and inverse quantization unit 106 is used for the reconstruction of the video coding block. A residual block is reconstructed in the pixel domain. The reconstructed residual block is processed by the filter control analysis unit 107 and the filtering unit 108 to remove the block effect artifacts, and then the reconstructed residual block is added to a predictive block in the frame of the decoded picture buffer unit 110 to generate the reconstructed video coding block. The encoding unit 109 is used to encode various coding parameters and quantized transform coefficient. In the CABAC-based coding algorithm, the context content may be based on neighbouring coding blocks, and may be used to encode information indicating the determined intra prediction mode and output a bitstream of the video signal. The decoded picture buffer unit 110 is configured to store the reconstructed video coding block for prediction reference. As the video picture encoding proceeds, new reconstructed video coding blocks are continuously generated, and these reconstructed video coding blocks are stored in the decoded picture buffer unit 110.

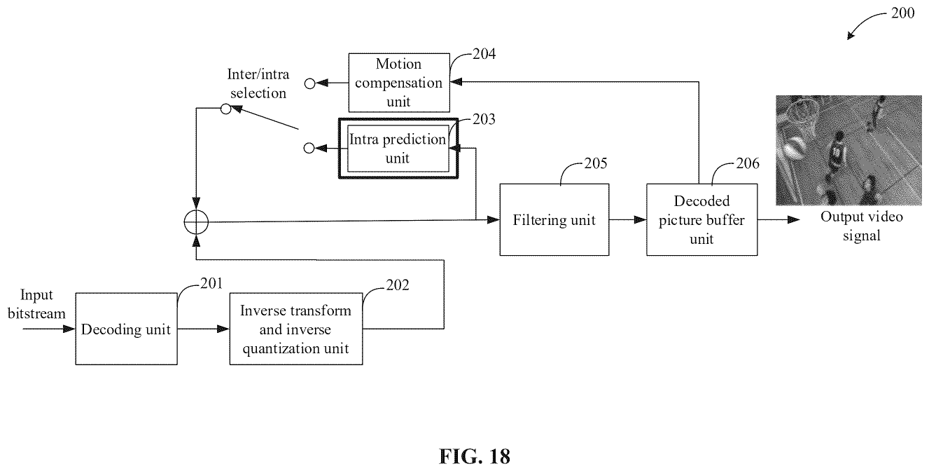

Referring to FIG. 18, a block diagram of a composition of a decoder according to an embodiment of the present disclosure is illustrated. As illustrated in FIG. 18, a decoder (specifically, a “video decoder”) 200 includes a decoding unit 201, an inverse transform and inverse quantization unit 202, an intra prediction unit 203, a motion compensation unit 204, a filtering unit 205, a decoded picture buffer unit 206, and the like. The decoding unit 201 may implement the header information decoding and the CABAC decoding, and the filtering unit 205 may implement the de-blocking filtering and the SAO filtering. After the input video signal is subjected to the encoding process illustrated in FIG. 15, a bitstream of the video signal is output. The bitstream is input into decoder 200, and first passes through the decoding unit 201 to obtain the decoded transform coefficient. The transform coefficient is processed by the inverse transform and inverse quantization unit 202 to generate a residual block in the pixel domain. The intra prediction unit 203 may be used to generate prediction data for a current decoding block of the video based on the determined intra prediction mode and based on the data from a previously decoded block of the current frame or picture. The motion compensation unit 204 is used to determine the prediction information for the decoding block of the video by parsing the motion vector and other associated syntax elements, and use the prediction information to generate a predictive block of the decoding block of the video being decoded. A decoded video block is formed by summing a residual block from the inverse transform and inverse quantization unit 202 with the corresponding predictive block generated by the intra prediction unit 203 or the motion compensation unit 204. The decoded video signal passes through the filtering unit 205 to remove the block effect artifact, so that the video quality can be improved. The decoded video block is then stored in the decoded picture buffer unit 206. The decoded picture buffer unit 206 is configured to store the reference picture for subsequent intra prediction or motion compensation, and is also used for the output of the video signal, that is, the recovered original video signal is obtained.

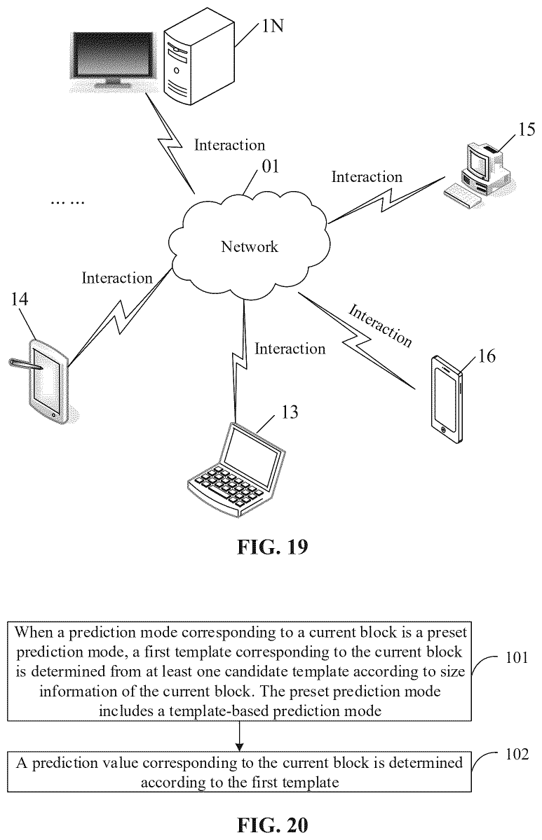

Further, the embodiments of the present disclosure further provide a network architecture of a codec system including an encoder and a decoder. FIG. 19 illustrates a diagram of a network architecture of a codec system according to an embodiment of the present disclosure. As illustrated in FIG. 19, the network architecture includes one or more electronic devices (i.e., electronic device 13 to electronic device 1N) and a communication network 01. The electronic devices 13-1N may perform video interaction through the communication network 01. In the process of implementation, the electronic device may be various types of devices having the video encoding and decoding functions. For example, the electronic device may include a smartphone, a tablet computer, a personal computer, a personal digital assistant, a navigator, a digital phone, a video phone, a television, a sensing device, a server, or the like, which is not limited in the embodiments of the present disclosure. Here, the decoder or encoder described in the embodiments of the present disclosure may be the above-described electronic device.

It should be noted that the methods of the embodiments of the present disclosure are mainly applied to the intra prediction unit 103 as illustrated in FIG. 17 and the intra prediction unit 203 as illustrated in FIG. 18. That is, the embodiments of the present disclosure may be applied to an encoder or a decoder, or may be applied to both the encoder and the decoder, which would not be limited in the embodiments of the present disclosure.

It should also be noted that, when applied to the intra prediction unit 103, the “current block” specifically refers to a coding block currently to be intra-predicted. When applied to the intra prediction unit 203, the “current block” specifically refers to a decoding block currently to be intra-predicted.

The embodiments of the present disclosure provide a decoding method. The decoding method is applied to a decoder. FIG. 20 is a flowchart of the decoding method according to an embodiment of the present disclosure. As illustrated in FIG. 20, the method that the decoder performs the decoding processing may include the following operations.

In operation 101, when a prediction mode corresponding to a current block is a preset prediction mode, a first template corresponding to the current block is determined from at least one candidate template according to size information of the current block. The preset prediction mode includes a template-based prediction mode.

In the embodiments of the present disclosure, the first template corresponding to the current block may be determined first. When the prediction mode corresponding to the current block is a preset prediction mode, the first template corresponding to the current block may be determined from at least one candidate template according to the size information of the current block.

It should be noted that the decoding method according to the embodiment of the present disclosure is applied to a decoder. Further, the decoding method may include an intra prediction method, and more specifically, the decoding method may include a colour component prediction method. Here, the video picture may be partitioned into multiple decoding blocks, and each decoding block may include the first colour component, the second colour component, and the third colour component. The current block in the embodiments of the present disclosure refers to a decoding block currently to be intra-predicted in the video picture.

Here, when it is necessary to predict the first colour component, the component to be predicted is the first colour component. When it is necessary to predict the second colour component, the component to be predicted is the second colour component. When it is necessary to predict the third colour component, the component to be predicted is the third colour component. In addition, assuming that the first colour component of the current block is predicted and the first colour component is a luma component (i.e., the component to be predicted is a luma component), the current block may also be referred to as a luma block. Alternatively, assuming that the second colour component of the current block is predicted and the second colour component is a chroma component (i.e., the component to be predicted is a chroma component), the current block may also be referred to as a chroma block.

It should be noted that, in the embodiments of the present disclosure, the first template corresponding to the current block may be a candidate template in a template set corresponding to the current block. The candidate templates corresponding to the current block include multiple candidate templates of different template types.

It may be understood that, in the embodiments of the present disclosure, a template set corresponding to the current block may be first constructed based on different template types, and then the first template corresponding to the current block may be determined from the candidate templates in the template set.

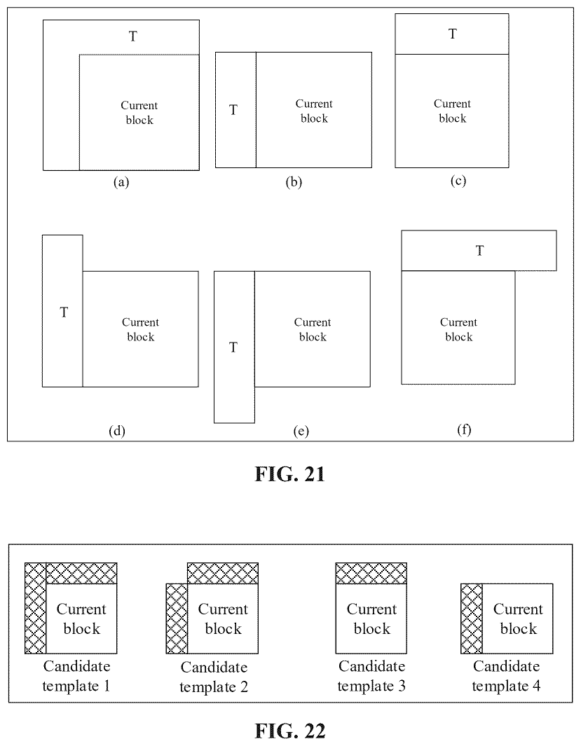

Exemplarily, in the embodiments of the present disclosure, FIG. 21 is a second diagram of template types. As illustrated in FIG. 21, when the above-left reference sample, the above reference sample, and the left reference sample are all available, the template shape is as illustrated in (a). When only the left reference sample is available, the template shape is illustrated in (b). When only the above reference sample is available, the template shape is illustrated in (c). When only the left reference sample and the above-left reference sample are available, the template shape is illustrated in (d). When only the left reference sample and the bottom-left reference sample are available, the template shape is as illustrated in (c). When only the above reference sample and the above-right reference sample are available, the template shape is illustrated in (f).

Further, in the embodiments of the present disclosure, when constructing the template set corresponding to the current block according to the template types, the template reference sample(s) of the current block may be first determined according to the template type and the template size corresponding to the template type. Then the candidate templates of the current block may be determined according to the template reference sample(s). Finally, the construction of the template set may be completed.

It should be noted that, in the embodiments of the present disclosure, the first candidate template in the template set may be a template that includes the left neighbouring reconstructed sample and the above neighbouring reconstructed sample of the current block, such as the TL template. The second candidate template in the template set may be a template that includes the above neighbouring reconstructed sample of the current block, such as the T template. The third candidate template in the template set may be a template that includes the left neighbouring reconstructed sample of the current block, such as the L template.

That is, in the embodiments of the present disclosure, the at least one candidate template corresponding to the current block may include the TL template, the T template, and the L template.

Exemplarily, in the embodiments of the present disclosure, FIG. 22 is a diagram of candidate templates. As illustrated in FIG. 22, corresponding to four different template types, the finally generated candidate templates of the current block may also include four types, such as the candidate template 1 (TL template), the candidate template 2 (TL template), the candidate template 3 (T template), and the candidate template 4 (L template).

Exemplarily, in some embodiments, the first template corresponding to the current block may be the first candidate template in the template set corresponding to the current block, such as the candidate template 1.

Exemplarily, in some embodiments, the first template corresponding to the current block may be the second candidate template in the template set corresponding to the current block, such as the candidate template 3.

Exemplarily, in some embodiments, the first template corresponding to the current block may be the third candidate template in the template set corresponding to the current block, such as the candidate template 4.

Further, in the embodiments of the present disclosure, the preset prediction mode may include the template-based prediction mode. That is, in the present disclosure, the prediction manner involving the use of the template in the prediction process may be uniformly determined as the preset prediction mode.

Exemplarily, in some embodiments, the preset prediction mode may include any one of the template-based prediction modes such as the Intra TMP, the IBC, the Inter Template Matching Prediction, the TIMD, or the DIMD.

It may be understood that in the embodiments of the present disclosure, for the intraTMP, the best matching block found through the template matching is finally taken as the determined prediction block. That is, the intraTMP may be a template-based prediction mode, and thus the intraTMP may be used as the preset prediction mode.

It may be understood that in the embodiments of the present disclosure, for the template matching of the IBC, the best matching block of the current block is determined through the template matching method within the search range. That is, the template matching of the IBC may be a template-based prediction mode, and thus the template matching of the IBC may be used as the preset prediction mode.

It may be understood that in the embodiments of the present disclosure, for the Inter Template Matching Prediction, the best matching block of the current block is determined through the template matching method within the reference frame. That is, the Inter Template Matching Prediction may be the template-based prediction mode, and thus the Inter Template Matching Prediction may be used as the preset prediction mode.

It may be understood that in the embodiments of the present disclosure, for the TIMD, some candidate intra prediction modes are used for prediction on the templates, and one or two intra prediction modes with the lowest cost are selected as the intra prediction values of the current block. That is, the TIMD may be the template-based prediction mode, and thus the TIMD may be used as the preset prediction mode.

It may be understood that in the embodiments of the present disclosure, the process of the DIMD is similar to that of the TIMD. Although the prediction on the template is not performed for the DIMD, the regions of the templates are used. Therefore, the DIMD may be the template-based prediction mode, and the DIMD may be used as the preset prediction mode.

It may be understood that in the embodiments of the present disclosure, other template-based prediction modes except the Intra Template Matching Prediction, the IBC, the Inter Template Matching Prediction, the TIMD and the DIMD may be used as the preset prediction mode, which is not specifically limited in the present disclosure.

It may be understood that in the embodiments of the present disclosure, when it is determined that the prediction mode corresponding to the current block is the preset prediction mode, the size information of the current block may be used to select and restrict the candidate template. Specifically, the first template corresponding to the current block may be determined from at least one candidate template according to the size information corresponding to the current block.

It should be noted that in the embodiments of the present disclosure, the first template is a template used when the prediction is performed on the current block based on the preset prediction mode.

It should be noted that in the embodiments of the present disclosure, the size information corresponding to the current block may include information related to the height and/or width corresponding to the current block.

Exemplarily, in some embodiments, the size information corresponding to the current block may include a height and a width of the current block, and the height and the width of the current block may be absolute values of the height and width of the current block, respectively.

Further, in the embodiments of the present disclosure, the bitstream is decoded to determine prediction mode identification information corresponding to the current block. When a value of the prediction mode identification information is a first value, it may be determined that the prediction mode corresponding to the current block is the preset prediction mode. When the value of the prediction mode identification information is a second value, it may be determined that the prediction mode corresponding to the current block is not the preset prediction mode.

It may be understood that in the embodiments of the present disclosure, the prediction mode identification information may be used to determine whether the template-based prediction mode is used for the current block (i.e., whether the prediction mode of the current block is the preset prediction mode), and further, whether prediction is performed on the current block by using the preset prediction mode is determined through the prediction mode identification information.

Exemplarily, in some embodiments, the bitstream is decoded to determine a variable which is taken as the prediction mode identification information, so that the prediction mode identification information can be determined through the value of the variable.

It should be noted that in the present disclosure, the value of the prediction mode identification information may be the first value or the second value. The manner to determine the prediction value of the current block varies with different values of the prediction mode identification information. Specifically, based on the value of the prediction mode identification information, when determining the prediction value of the current block, using the preset prediction mode may be selected, or not using the preset prediction mode may be selected.

Exemplarily, in some embodiments, assuming that the preset prediction mode is the Intra TMP, the prediction mode identification information may be understood as a flag bit indicating whether the intra TMP is used. When the value of the prediction mode identification information is the first value, the prediction value of the current block may be determined by using the intra TMP. When the value of the prediction mode identification information is the second value, the prediction value of the current block may be determined without using the intra TMP.

Exemplarily, in some embodiments, the first value may be set to be 1 and the second value may be set to be 0. Alternatively, the first value is set to be true and the second value is set to be false. The first value and the second value are not limited in the present disclosure.

Exemplarily, in some embodiments, assuming that the preset prediction mode is the intra TMP, the flag intra_tmp_flag may be used to represent the prediction mode identification information, that is, intra_tmp_flag is used as the flag for the intra TMP.

Exemplarily, in some embodiments, the value of intra_tmp_flag is 1, which represents that the intra TMP is used to determine the prediction value of the current block. The value of intra_tmp_flag is 0, which represents that the intra TMP is not used when determining the prediction value of the current block.

It may be understood that in the embodiments of the present disclosure, after the value of the prediction mode identification information is determined to be the first value (i.e., after it is determined based on the value of the prediction mode identification information that the prediction value of the current block is determined by using the preset prediction mode), the first template corresponding to the current block may be further determined from at least one candidate templates according to the size information corresponding to the current block.

Further, in the embodiments of the present disclosure, when the first template corresponding to the current block is determined from the at least one candidate template according to the size information of the current block, the bitstream is decoded to determine the first template indication information corresponding to the current block. When the value of the first template indication information is the third value, it may be determined that the first template is the first candidate template.

It should be noted that, in the embodiments of the present disclosure, the first candidate template may be a candidate template among at least one candidate template corresponding to the current block. For example, the first candidate template may be a TL template among the at least one candidate template.

It may be understood that in the embodiments of the present disclosure, the first template indication information may be used to determine whether the first candidate template is used for the current block. That is, the first template indication information may indicate whether the first candidate template is used to perform prediction of the preset prediction mode on the current block.

Exemplarily, in some embodiments, the bitstream is decoded to determine a variable which is taken as the first template indication information, so that the first template indication information may be determined through the value of the variable.

It should be noted that in the present disclosure, the value of the first template indication information may be the third value or the fourth value. Specifically, based on the value of the first template indication information, when performing the preset prediction mode, the first candidate template may be chosen to be used, or one may choose not to use the first candidate template and use other templates instead, such as other templates from the at least one candidate template that are not the first candidate template.

Exemplarily, in some embodiments, the third value may be set to be 0 and the fourth value may be set to be 1. Alternatively, the third value may be set to be false and the fourth value may be set to be true. The third value and the fourth value are not limited in the present disclosure.

Exemplarily, in some embodiments, assuming that the preset prediction mode is the intra TMP, the flag intra_tmp_alternative_template_flag may be used to represent the first template indication information. For example, the value of intra_tmp_alternative_template_flag is 0, which represents that the first candidate template is determined as the first template corresponding to the current block. The value of intra_tmp_alternative_template_flag is 1, which represents that the first candidate template is not determined as the first template corresponding to the current block, and another template is selected instead as the first template corresponding to the current block.

Accordingly, in the embodiments of the present disclosure, after determining the first template indication information corresponding to the current block, when the value of the first template indication information is the fourth value, it may be determined that the first template is not the first candidate template. In this case, when the size information of the current block satisfies the preset size condition, it is necessary to further determine the second template indication information corresponding to the current block, thereby determining the first template based on the second template indication information.

That is, in the embodiments of the present disclosure, when the first template corresponding to the current block is determined from the at least one candidate template according to the size information of the current block, if the value of the first template indication information is the fourth value and the size information of the current block satisfies the preset size condition, it is necessary to further decode the bitstream to determine the second template indication information corresponding to the current block, and determine the first template according to the second template indication information.

It may be understood that in the embodiments of the present disclosure, when it is determined not to use the first candidate template according to the first template indication information, it is necessary to further determine whether to use the candidate templates other than the first candidate template according to the size information corresponding to the current block. Specifically, when the size information corresponding to the current block satisfies the preset size condition, it is determined that the candidate templates other than the first candidate template may be used, and the second template indication information may continue to be determined, so as to determine the first template according to the second template indication information.

It should be noted that, in the embodiments of the present disclosure, the preset size condition may be used to restrict the use of the candidate template based on the size of the current block.

Further, in the embodiments of the present disclosure, when the first template is determined according to the second template indication information, if the value of the second template indication information is the fifth value, it may be determined that the first template is the second candidate template, and if the value of the second template indication information is the sixth value, it may be determined that the first template is the third candidate template.

It should be noted that, in the embodiments of the present disclosure, each of the second candidate template and the third candidate template may be a respective candidate template among at least one candidate template corresponding to the current block. For example, the second candidate template may be a T template among the at least one candidate template, and the third candidate template may be an L template among the at least one candidate template.

It may be understood that in the embodiments of the present disclosure, the second template indication information may be used to determine whether the second candidate template and/or the third candidate template is (arc) used for the current block. That is, the second template indication information may indicate whether the second candidate template and/or the third candidate template is (are) used to perform prediction of the preset prediction mode on the current block.

Exemplarily, in some embodiments, the bitstream is decoded to determine a variable which is taken as the second template indication information, so that the second template indication information may be determined through the value of the variable.

It should be noted that in the present disclosure, the value of the second template indication information may be the fifth value or the sixth value. Specifically, based on the value of the second template indication information, when performing the preset prediction mode, the second candidate template may be chosen to be used, or the third candidate template may be chosen to be used.

Exemplarily, in some embodiments, the fifth value may be set to be 0 and the sixth value may be set to be 1. Alternatively, the fifth value may be set to be false and the sixth value may be set to be true. The fifth value and the sixth value are not limited in the present disclosure.

Exemplarily, in some embodiments, assuming that the preset prediction mode is the intra TMP, the flag intra_tmp_template_idx may be used to represent the second template indication information. For example, the value of intra_tmp_template_idx is 0, which represents that the second candidate template is determined as the first template corresponding to the current block. The value of intra_tmp_template_idx is 1, which represents that the third candidate template is determined as the first template corresponding to the current block.

Further, in the embodiments of the present disclosure, when the first template corresponding to the current block is determined from the at least one candidate template according to the size information of the current block, if the value of the first template indication information is the fourth value and the size information of the current block does not satisfy the preset size condition, the determination of the second template indication information may be skipped, and the longest side of the current block may be directly determined according to the size information of the current block. Then the first template may be determined from the at least one candidate template according to the longest side of the current block.

It may be understood that in the embodiments of the present disclosure, when it is determined according to the first template indication information that the first candidate template is not used, it is necessary to further determine according to the size information corresponding to the current block whether to use candidate templates other than the first candidate template. Specifically, when the size information corresponding to the current block does not satisfy the preset size condition, it is not necessary to determine the first template according to the second template indication information, and the first template may be directly indicated according to the longest side of the current block.

It may be understood that, in the embodiments of the present disclosure, when the width of the current block is greater than the height of the current block, a side corresponding to the width may be determined as the longest side of the current block. When the height of the current block is greater than the width of the current block, a side corresponding to the height may be determined as the longest side of the current block.

That is, in the embodiments of the present disclosure, the longest side of the current block being the side corresponding to the height can also be understood as the height of the current block being greater than the width, and the longest side of the current block being the side corresponding to the width can also be understood as the width of the current block being greater than the height.

Accordingly, in the embodiments of the present disclosure, when the value of the first template indication information is the fourth value and the size information of the current block does not satisfy the preset size condition, if the height of the current block is greater than the width of the current block (i.e., the longest side of the current block is the side corresponding to the height), it may be considered that the left neighbouring region of the current block includes more neighbouring samples than the above neighbouring region. Therefore, the L template that includes more left neighbouring samples may be determined as the first template, that is, the third candidate template (L template) that includes the left neighbouring reconstructed sample of the current block is determined as the first template.

Accordingly, in the embodiments of the present disclosure, when the value of the first template indication information is the fourth value and the size information of the current block does not satisfy the preset size condition, if the width of the current block is greater than the height of the current block (i.e., the longest side of the current block is the side corresponding to the width), it may be considered that the above neighbouring region of the current block includes more neighbouring samples than the left neighbouring region. Therefore, the T template that includes more above neighbouring samples may be determined as the first template, that is, the second candidate template (T template) that includes the above neighbouring reconstructed sample of the current block is determined as the first template.

Exemplarily, in some embodiments, assuming that the height of the current block is 4 and the width of the current block is 1, it can be determined that the longest side of the current block is the side corresponding to the height, and thus the L template corresponding to the longest side may be used as the first template.

Exemplarily, in some embodiments, assuming that the height of the current block is 1 and the width of the current block is 8, it is determined that the longest side of the current block is the side corresponding to the width, and thus the T template corresponding to the longest side may be used as the first template.

Further, in the embodiments of the present disclosure, when the first template corresponding to the current block is determined from at least one candidate template according to the size information of the current block, if the size information of the current block satisfies the preset size condition, the bitstream may be decoded to determine the first template indication information corresponding to the current block. When the value of the first template indication information is the third value, it may be determined that the first template is the first candidate template.

It should be noted that, in the embodiments of the present disclosure, the first candidate template may be a candidate template among at least one candidate template corresponding to the current block. For example, the first candidate template may be a TL template among the at least one candidate template.

That is, in the embodiments of the present disclosure, when the first template corresponding to the current block is determined from at least one candidate template according to the size information of the current block, whether to use the first candidate template may be first determined according to the size information corresponding to the current block. Specifically, when the size information corresponding to the current block satisfies the preset size condition, it is determined that the first candidate template can be used, and then the first template indication information may be determined.

It should be noted that, in the embodiments of the present disclosure, the preset size condition may be used to restrict the use of the candidate template based on the size of the current block.

Accordingly, in the embodiments of the present disclosure, when the first template corresponding to the current block is determined from the at least one candidate template according to the size information of the current block, if the size information of the current block does not satisfy the preset size condition, it is not necessary to determine the first template according to the first template indication information, and the first template can be directly indicated. For example, the first candidate template may be determined as the first template.

It may be understood that in the embodiments of the present disclosure, the first template indication information may be used to determine whether the first candidate template is used for the current block. That is, the first template indication information may indicate whether the first candidate template is used to perform prediction of the preset prediction mode on the current block.

Exemplarily, in some embodiments, the bitstream is decoded to determine a variable which is taken as the first template indication information, so that the first template indication information may be determined through the value of the variable.

It should be noted that in the present disclosure, the value of the first template indication information may be the third value or the fourth value. Specifically, based on the value of the first template indication information, when performing the preset prediction mode, the first candidate template may be chosen to be used, or one may choose not to use the first candidate template and use other templates instead, such as other templates from the at least one candidate template that are not the first candidate template.

Exemplarily, in some embodiments, the third value may be set to be 0 and the fourth value may be set to be 1. Alternatively, the third value may be set to be false and the fourth value may be set to be true. The third value and the fourth value are not limited in the present disclosure.

Exemplarily, in some embodiments, assuming that the preset prediction mode is the intra TMP, the flag intra_tmp_alternative_template_flag may be used to represent the first template indication information. For example, the value of intra_tmp_alternative_template_flag is 0, which represents that the first candidate template is determined as the first template corresponding to the current block. The value of intra_tmp_alternative_template_flag is 1, which represents that the first candidate template is not determined as the first template corresponding to the current block, and another template is selected instead as the first template corresponding to the current block.

Accordingly, in the embodiments of the present disclosure, after determining the first template indication information corresponding to the current block, when the value of the first template indication information is the fourth value, it may be determined that the first template is not the first candidate template. In this case, it is necessary to further decode the bitstream to determine the second template indication information corresponding to the current block, so as to determine the first template according to the second template indication information.

Further, in the embodiments of the present disclosure, when the first template is determined according to the second template indication information, if the value of the second template indication information is the fifth value, it may be determined that the first template is the second candidate template, and if the value of the second template indication information is the sixth value, it may be determined that the first template is the third candidate template.

It should be noted that, in the embodiments of the present disclosure, each of the second candidate template and the third candidate template may be a respective candidate template among at least one candidate template corresponding to the current block. For example, the second candidate template may be a T template among the at least one candidate template, and the third candidate template may be an L template among the at least one candidate template.

It may be understood that in the embodiments of the present disclosure, the second template indication information may be used to determine whether the second candidate template and/or the third candidate template is (are) used for the current block. That is, the second template indication information may indicate whether the second candidate template and/or the third candidate template is (are) used to perform prediction of the preset prediction mode on the current block.

Exemplarily, in some embodiments, the bitstream is decoded to determine a variable which is taken as the second template indication information, so that the second template indication information may be determined through the value of the variable.

It should be noted that in the present disclosure, the value of the second template indication information may be the fifth value or the sixth value. Specifically, based on the value of the second template indication information, when performing the preset prediction mode, the second candidate template may be chosen to be used, or the third candidate template may be chosen to be used.

Exemplarily, in some embodiments, the fifth value may be set to be 0 and the sixth value may be set to be 1. Alternatively, the fifth value may be set to be false and the sixth value may be set to be true. The fifth value and the sixth value are not limited in the present disclosure.

Exemplarily, in some embodiments, assuming that the preset prediction mode is the intra TMP, the flag intra_tmp_template_idx may be used to represent the second template indication information. For example, the value of intra_tmp_template_idx is 0, which represents that the second candidate template is determined as the first template corresponding to the current block. The value of intra_tmp_template_idx is 1, which represents that the third candidate template is determined as the first template corresponding to the current block.

That is, in the embodiments of the present disclosure, it is possible to indicate which one of the at least one candidate template is the first template corresponding to the current block. For example, the first template is indicated by using the first template indication information and/or the second template indication information. In the process of determining the first template, it is necessary to use the size information corresponding to the current block to restrict the candidate template.

It can be understood that in the embodiments of the present disclosure, based on the preset size condition, the use of the candidate template may be restricted according to the size of the current block. Specifically, when the implications included in the size information corresponding to the current block are different, the corresponding preset size conditions may be different.

Further, in the embodiments of the present disclosure, when the size information includes a height and a width of the current block, accordingly, the preset size condition includes: the width being less than a first numerical multiple of the height and the height being less than a second numerical multiple of the width.

It may be understood that in the embodiments of the present disclosure, the first numerical multiple and the second numerical multiple may be used to restrict the ratio between the width and the height of the current block.

It should be noted that in the embodiments of the present disclosure, the first numerical multiple and the second numerical multiple may be any numerical values greater than 0, and the first numerical multiple and the second numerical multiple may be the same or different, which are not specifically limited in the present disclosure.

Exemplarily, in the embodiments of the present disclosure, the first numerical multiple may be 4, and the second numerical multiple may be 8.

Exemplarily, in the embodiments of the present disclosure, both the first numerical multiple and the second numerical multiple may be 4.

It may be understood that, in the embodiments of the present disclosure, when determining whether the size information of the current block satisfies the preset size condition, if the width of the current block is less than the first numerical multiple of the height and the height of the current block is less than the second numerical multiple of the width, it may be determined that the size information of the current block satisfies the preset size condition. Accordingly, if the width of the current block is greater than or equal to the first numerical multiple of the height, or the height of the current block is greater than or equal to the second numerical multiple of the width, it may be determined that the size information of the current block does not satisfy the preset size condition.

Exemplarily, in some embodiments, assuming that the preset prediction mode is the intra TMP, taking three candidate templates (i.e., a TL template, a T template, and an L template) as an example, the first candidate template is the TL template, the second candidate template is the T template, the third candidate template is the L template, and both the first ratio threshold and the second ratio threshold are 4. The preset size condition is that the height-to-width ratio is less than the first ratio threshold and the width-to-height ratio is less than the second ratio threshold, that is, the preset size condition may be represented as width<height×4 && height<width×4. The flag intra_tmp_flag represents the prediction mode identification information. The flag intra_tmp_alternative_template_flag represents the first template indication information, and the flag intra_tmp_template_idx represents the second template indication information. Decoded information in the bitstream is as follows:

```
intra_tmp_flag
if(intra_tmp_flag){
  intra_tmp_alternative_template_flag
  if(intra_tmp_alternative_template_flag && width<height×4 &&
  height<width×4) {
    intra_tmp_template_idx
  }
}
```

Herein, intra_tmp_flag indicates whether the intra TMP is used for the current block. When the intra TMP is used for the current block, the decoder parses intra_tmp_alternative_template_flag, and intra_tmp_alternative_template_flag indicates whether another template is used for the current block. When the value of template used current intra_tmp_alternative_template_flag is 0, the TL template is used for the current block. When the value of intra_tmp_alternative_template_flag is 1, and the current block satisfies the conditions that the width is less than four times the height and the height is less than four times the width (i.e., the height and the width satisfy the conditions of width<height×4 and height<width×4), the decoder parses intra_tmp_template_idx, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

Accordingly, in the embodiments of the present disclosure, when the height and the width of the current block do not satisfy the conditions of width<height×4 and height<width×4, the candidate template corresponding to the longest side may be selected by default. For example, when the longest side is the side corresponding to the height, the L template is selected, and when the longest side is the side corresponding to the width, the T template is selected.

Exemplarily, in some embodiments, assuming that the preset prediction mode is the intra TMP, taking three candidate templates (i.e., a TL template, a T template, and an L template) as an example, the first candidate template is the TL template, the second candidate template is the T template, the third candidate template is the L template, and both the first ratio threshold and the second ratio threshold are 4. The preset size condition is that the height-to-width ratio is less than the first ratio threshold and the width-to-height ratio is less than the second ratio threshold, that is, the preset size condition may be represented as width<height×4 && height<width×4. The flag intra_tmp_flag represents the prediction mode identification information. The flag intra_tmp_alternative_template_flag represents the first template indication information, and the flag intra_tmp_template_idx represents the second template indication information. Decoded information in the bitstream is as follows:

```
intra_tmp_flag
if(intra_tmp_flag){
  if(width<height×4 && height<width×4){
    intra_tmp_alternative_template_flag
    if(intra_tmp_alternative_template_flag) {
      intra_tmp_template_idx
    }
  }
}
```

Herein, intra_tmp_flag indicates whether the intra TMP is used for the current block. When the intra TMP is used for the current block, it is necessary to first determine whether the current block satisfies the conditions that the width is less than four times the height and the height is less than four times the width (i.e., whether the height and the width satisfy the conditions of width<height×4 and height<width×4). If the conditions are not satisfied, the parsing of intra_tmp_alternative_template_flag is skipped, and the TL template is directly selected by default. If the conditions are satisfied, the decoder parses intra_tmp_alternative_template_flag, and intra_tmp_alternative_template_flag indicates whether another template is used for the current block. When the value of intra_tmp_alternative_template_flag is 0, the TL template is used for the current block. When the value of intra_tmp_alternative_template_flag is 1, the decoder parses intra_tmp_template_idx, which indicates whether the T template or the L template is used for the current block. For example, a value of intra_tmp_template_idx being 0 represents that the T template is used for the current block, and a value of intra_tmp_template_idx being 1 represents that the L template is used for the current block.

Further, in the embodiments of the present disclosure, when the size information includes a height and a width of the current block, accordingly, the preset size condition includes: the height being greater than the first size threshold and the width being greater than the second size threshold.

It may be understood that in the embodiments of the present disclosure, the first size threshold may be used to restrict the height (an absolute value of height) of the current block, and accordingly, the second size threshold may be used to restrict the width (an absolute value of the width) of the current block.

It should be noted that in the embodiments of the present disclosure, the first size threshold and the second size threshold may be any numerical values greater than 0, and the first size threshold and the second size threshold may be the same or different, which are not specifically limited in the present disclosure.

Exemplarily, in the embodiments of the present disclosure, the first size threshold may be 8, and the second size threshold may be 4.

Exemplarily, in the embodiments of the present disclosure, the first size threshold and the second size threshold may both be 8.

It may be understood that, in the embodiments of the present disclosure, when determining whether the size information of the current block satisfies the preset size condition, if the height of the current block is greater than the first size threshold and the width of the current block is greater than the second size threshold, it may be determined that the size information of the current block satisfies the preset size condition. Accordingly, if the height of the current block is less than or equal to the first size threshold, or the width of the current block is less than or equal to the second size threshold, it may be determined that the size information of the current block does not satisfy the preset size condition.

Exemplarily, in some embodiments, assuming that the preset prediction mode is the intra TMP, taking three candidate templates (i.e., a TL template, a T template, and an L template) as an example, the first candidate template is the TL template, the second candidate template is the T template, the third candidate template is the L template, and the first size threshold and the second size threshold are both 4. The preset size condition is that the height is greater than the first size threshold and the width is greater than the second size threshold, that is, the preset size condition may be represented as width>4&&height>4. The flag intra_tmp_flag represents the prediction mode identification information, the flag intra_tmp_alternative_template_flag represents the first template indication information, and the flag intra_tmp_template_idx represents the second template indication information. Decoded information in the bitstream is as follows:

```
intra_tmp_flag
if(intra_tmp_flag){
  intra_tmp_alternative_template_flag
  if(intra_tmp_alternative_template_flag && width>4 && height>4) {
    intra_tmp_template_idx
  }
}
```

Herein, intra_tmp_flag indicates whether the intra TMP is used for the current block. When the intra TMP is used for the current block, the decoder parses intra_tmp_alternative_template_flag, and intra_tmp_alternative_template_flag indicates whether another template is used for the current block. When the value of intra_tmp_alternative_template_flag is 0, the TL template is used for the current block. When the value of intra_tmp_alternative_template_flag is 1 and the width and height of the current block satisfy the conditions of width>4 and height>4, the decoder parses intra_tmp_template_idx, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

Accordingly, in the embodiments of the present disclosure, when the width and the height of the current block do not satisfy the conditions of width>4 and height>4, the candidate template corresponding to the longest side may be selected by default. For example, when the longest side is the side corresponding to the height, the L template is selected, and when the longest side is the side corresponding to the width, the T template is selected.

Exemplarily, in some embodiments, assuming that the preset prediction mode is the intra TMP, taking three candidate templates (i.e., a TL template, a T template, and an L template) as an example, the first candidate template is the TL template, the second candidate template is the T template, the third candidate template is the L template, and the first size threshold and the second size threshold are both 4. The preset size condition is that the height is greater than the first size threshold and the width is greater than the second size threshold, that is, the preset size condition may be represented as width>4&&height>4. The flag intra_tmp_flag represents the prediction mode identification information, the flag intra_tmp_alternative_template_flag represents the first template indication information, and the flag intra_tmp_template_idx represents the second template indication information. Decoded information in the bitstream is as follows:

```
intra_tmp_flag
if(intra_tmp_flag){
  if(width>4 && height>4){
    intra_tmp_alternative_template_flag
    if(intra_tmp_alternative_template_flag) {
      intra_tmp_template_idx
    }
  }
}
```

Herein, intra_tmp_flag indicates whether the intra TMP is used for the current block. When the intra TMP is used for the current block, it is necessary to first determine whether the width and height of the current block satisfy the conditions of width>4 and height>4. If the conditions are not satisfied, the parsing of intra_tmp_alternative_template_flag is skipped, and the TL template is directly selected by default. If the conditions are satisfied, the decoder parses intra_tmp_alternative_template_flag, which indicates whether another template is used for the current block. When the value of intra_tmp_alternative_template_flag is 0, the TL template is used for the current block. When the value of intra_tmp_alternative_template_flag is 1, the decoder parses intra_tmp_template_idx, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

Further, in the embodiments of the present disclosure, when the size information includes a height and a width of the current block, accordingly, the preset size condition include: the width being less than the first numerical multiple of the height and the height being less than the second numerical multiple of the width, and the height being greater than the first size threshold and the width being greater than the second size threshold.

It may be understood that in the embodiments of the present disclosure, the first numerical multiple and the second numerical multiple may be used to restrict the ratio between the width and the height of the current block. The first size threshold may be used to restrict the height (an absolute value of height) of the current block, and the second size threshold may be used to restrict the width (an absolute value of the width) of the current block.

It should be noted that in the embodiments of the present disclosure, the first numerical multiple and the second numerical multiple may be any numerical values greater than 0, and the first numerical multiple and the second numerical multiple may be the same or different, which are not specifically limited in the present disclosure.

It should be noted that in the embodiments of the present disclosure, the first size threshold and the second size threshold may be any numerical values greater than 0, and the first size threshold and the second size threshold may be the same or different, which are not specifically limited in the present disclosure.

Exemplarily, in the embodiments of the present disclosure, the first numerical multiple and the second numerical multiple may both be 4, and the first size threshold and the second size threshold may both be 8.

It may be understood that in the embodiments of the present disclosure, when determining whether the size information of the current block satisfies the preset size condition, if the width of the current block is less than the first numerical multiple of the height and the height of the current block is less than the second numerical multiple of the width, and the height of the current block is greater than the first size threshold and the width of the current block is greater than the second size threshold, it may be determined that the size information of the current block satisfies the preset size condition. Accordingly, when the width of the current block is greater than or equal to the first numerical multiple of the height, or the height of the current block is greater than or equal to the second numerical multiple of the width, or the height of the current block is less than or equal to the first size threshold, or the width of the current block is less than or equal to the second size threshold, it may be determined that the size information of the current block does not satisfy the preset size condition.

Exemplarily, in some embodiments, assuming that the preset prediction mode is the intra TMP, taking three candidate templates (i.e., a TL template, a T template, and an L template) as an example, the first candidate template is the TL template, the second candidate template is the T template, the third candidate template is the L template, the first ratio threshold and the second ratio threshold are both 4, and the first size threshold and the second size threshold are both 4. The preset size condition is that the height-to-width ratio is less than the first ratio threshold and the width-to-height ratio is less than the second ratio threshold, and the height is greater than the first size threshold and the width is greater than the second size threshold. That is, the preset size condition may be represented as width<height×4&&height<width×4&&width>4&&height>4). The flag intra_tmp_flag represents the prediction mode identification information, the flag intra_tmp_alternative_template_flag represents the first template indication information, and the flag intra_tmp_template_idx represents the second template indication information. Decoded information in the bitstream is as follows:

```
intra_tmp_flag
if(intra_tmp_flag){
  intra_tmp_alternative_template_flag
  if(intra_tmp_alternative_template_flag && width<height×4 &&
    height<width×4 && width>4 && height>4) {
    intra_tmp_template_idx
  }
}
```

Herein, intra_tmp_flag indicates whether the intra TMP is used for the current block. When the intra TMP is used for the current block, the decoder parses intra_tmp_alternative_template_flag, and intra_tmp_alternative_template_flag indicates whether another template is used for the current block. When the value of intra_tmp_alternative_template_flag is 0, it is represented that the TL template is used for the current block. When the value of intra_tmp_alternative_template_flag is 1, when the current block satisfies the conditions that the width is less than four times the height and the height is less than four times the width (i.e., the height and width satisfy the condition of width<height×4 and height<width×4), and when the height and the width satisfy the conditions of width>4 and height>4, the decoder parses intra_tmp_template_idx, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

Accordingly, in the embodiments of the present disclosure, when the height and the width of the current block do not satisfy the conditions of width<height×4, height<width×4, width>4 and height>4, the candidate template corresponding to the longest side may be selected by default. For example, when the longest side is the side corresponding to the height, the L template is selected, and when the longest side is the side corresponding to the width, the T template is selected.

Exemplarily, in some embodiments, assuming that the preset prediction mode is the intra TMP, taking three candidate templates (i.e., a TL template, a T template, and an L template) as an example, the first candidate template is the TL template, the second candidate template is the T template, the third candidate template is the L template, the first ratio threshold and the second ratio threshold are both 4, and the first size threshold and the second size threshold are both 4. The preset size condition is that the height-to-width ratio is less than the first ratio threshold and the width-to-height ratio is less than the second ratio threshold, and the height is greater than the first size threshold and the width is greater than the second size threshold. That is, the preset size condition may be represented as width<height×4&&height<width×4&&width>4&&height>4). The flag intra_tmp_flag represents the prediction mode identification information, the flag intra_tmp_alternative_template_flag represents the first template indication information, and the flag intra_tmp_template_idx represents the second template indication information. Decoded information in the bitstream is as follows:

```
intra_tmp_flag
if(intra_tmp_flag){
  if(width<height×4 && height<width×4&& width>4 && height>4){
    intra_tmp_alternative_template_flag
    if(intra_tmp_alternative_template_flag) {
      intra_tmp_template_idx
    }
  }
}
```

Herein, intra_tmp_flag indicates whether the intra TMP is used for the current block. When the intra TMP is used for the current block, it is necessary to first determine whether the current block satisfies the conditions that the width is less than four times the height and the height is less than four times the width (i.e., whether the width and height satisfy the conditions of width<height×4 and height<width×4), and determine whether the height and width of the current block satisfy the conditions of width>4 and height>4. If the conditions are not satisfied, the parsing of intra_tmp_alternative_template_flag is skipped, and the TL template is directly selected by default. If the conditions are satisfied, the decoder parses intra_tmp_alternative_template_flag, and intra_tmp_alternative_template_flag indicates whether another template is used for the current block. When the value of intra_tmp_alternative_template_flag is 0, the TL template is used for the current block. When the value of intra_tmp_alternative_template_flag is 1, the decoder parses intra_tmp_template_idx, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

It may be understood that in the above examples of the embodiments of the present disclosure, different candidate templates are selected in an explicit manner, that is, information for selecting different templates needs to be signalled into the bitstream. The unnecessary overhead can be reduced by the method of restricting the candidate templates through the size information of the current block.

Further, in the embodiments of the present disclosure, some template-based prediction technologies (e.g., TIMD, DIMD, etc.) may derive an intra prediction mode according to the TL template, the T template, and the L template, respectively. In order not to increase additional overhead, different processing can be performed based on the analysis of the threshold condition.

It may be understood that in the embodiments of the present disclosure, the DIMD uses the gradients of the reconstructed samples neighbouring the current block to construct a histogram of the intra prediction modes. The two intra prediction modes with the highest values in the histogram are selected and denoted as mode0 and model. Together with the planar mode, the prediction values of the three intra prediction modes (i.e., mode0, model and the planar mode) are weighted.

It should be noted that, in the embodiments of the present disclosure, when implementing a position-related weight derivation method in the DIMD, a histogram for a T template, which is denoted as H_T, and a histogram for an L template, which is denoted as H_L, may be respectively constructed when constructing a histogram for a TL template. For X being 0 or 1, when H_T [modeX]>H_L [modeX]×2, modeX mainly depends on the T template, and modeX has a greater weight at the position closer to the above side. Otherwise, when H_L [modeX]>H_T [modeX]×2, modeX mainly depends on the L template, and modeX has a greater weight at the position closer to the left side. Otherwise, for the modeX, position-related weights are not used.

It may be understood that in the above position-related weight derivation method of the DIMD, whether the position-related weights are used is determined according to the data, and information such as a flag bit is not added. In this case, the size information may also be applied to restrict the weight derivation method. For example, when the block size satisfies a condition (e.g., the conditions of width<height×4 && height<width×4 or width>4 && height>4) are satisfied, the process may be performed according to the position-related weight derivation method of the DIMD. Otherwise, the process may be performed directly according to the method in which the position-related weights are not used.

In operation 102, a prediction value corresponding to the current block is determined according to the first template.

In the embodiments of the present disclosure, when the prediction mode corresponding to the current block is a preset prediction mode, after the first template corresponding to the current block is determined from the at least one candidate template according to the size information of the current block (i.e., after the first template corresponding to the current block is determined), the prediction value corresponding to the current block may be further determined according to the first template.

It should be noted that, in the embodiments of the present disclosure, in the process of performing prediction processing on the current block by using the preset prediction mode, the prediction processing process based on the template for the current block may be completed by using the determined first template (i.e., the prediction block corresponding to the current block may be obtained by using the first template), and then the prediction value corresponding to the current block may be determined.

Further, in the embodiments of the present disclosure, when the prediction value corresponding to the current block is determined according to the first template, the best matching block corresponding to the current block may be first determined based on the first template. Then the prediction value corresponding to the current block is determined according to the best matching block. For example, the reconstructed value corresponding to the best matching block may be determined as the prediction value of the current block.

It may be understood that in the embodiments of the present disclosure, after the first template of the current block is determined, the best matching block corresponding to the current block may be searched by using the first template, and finally the prediction value of the current block may be determined according to the obtained best matching block. For example, the best matching block is used as the prediction block of the current block, and the prediction value corresponding to the current block is further determined. The above method for determining the prediction value of the current block based on the first template may be applied to a case that the preset prediction mode is the intraTMP.

It may be understood that in the embodiments of the present disclosure, after the first template of the current block is determined, the best matching block corresponding to the current block may be searched by using the first template, and finally the prediction value of the current block may be determined according to the obtained best matching block. For example, the best matching block of the current block is determined within the search range by using the first template, and then the best matching block is used as the prediction block of the current block to determine the prediction value corresponding to the current block. The above method for determining the prediction value of the current block based on the first template may be applied to a case that the preset prediction mode is template matching of the IBC.

It may be understood that in the embodiments of the present disclosure, after the first template of the current block is determined, the best matching block corresponding to the current block may be searched by using the first template, and finally the prediction value of the current block may be determined according to the obtained best matching block. For example, the first template may be used to determine the best matching block of the current block by a template matching method in a reference frame, and then the best matching block may be used as the prediction block of the current block to determine the prediction value corresponding to the current block. The above method for determining the prediction value of the current block based on the first template may be applied to a case that the preset prediction mode is the inter template matching prediction.

It may be understood that in the embodiments of the present disclosure, after the first template of the current block is determined, the best matching block corresponding to the current block may be searched by using the first template, and finally the prediction value of the current block may be determined according to the obtained best matching block. For example, prediction may be performed on the first template by using some candidate intra prediction modes, and one or two intra prediction modes with the lowest cost may be used as intra prediction value(s) of the current block. Then the prediction value corresponding to the current block is determined. The above method for determining the prediction value of the current block based on the first template may be applied to a case that the preset prediction mode is the TIMD.

It may be understood that in the embodiments of the present disclosure, after the first template of the current block is determined, the best matching block corresponding to the current block may be searched by using the first template, and finally the prediction value of the current block may be determined according to the obtained best matching block. For example, the region of the first template may be used to determine one or two intra prediction modes with the lowest costs as the intra prediction value(s) of the current block, and then the prediction value corresponding to the current block may be determined. The above method for determining the prediction value of the current block based on the first template may be applied to a case that the preset prediction mode is the DIMD.

Further, in the embodiments of the present disclosure, after the prediction value of the current block is determined according to the first template corresponding to the current block, the reconstructed value of the current block may be further determined according to the prediction value of the current block.

It should be noted that in the embodiments of the present disclosure, the bitstream may be first decoded to determine the prediction residual corresponding to the current block, and then the reconstructed value of the current block may be further determined according to the prediction residual and the prediction value.

In summary, through the decoding method proposed in the operations 101 to 102, in the process of performing prediction processing on the current block by using the template-based prediction technology, the candidate templates may be screened and restricted by using the size information of the current block, thereby determining the first template for performing the prediction processing. In the process of screening and restricting the candidate templates, candidate templates that are not applicable to the current block may be eliminated based on the size information of the current block, thereby reducing unnecessary overhead or reducing interference caused by unreasonable results.

That is, according to the encoding and decoding methods proposed in the embodiments of the present disclosure, with respect to the problem that the derived result may be unreasonable when the ratio of a template is too small or the template size is too small, the candidate template can be restricted through the size information corresponding to the current block, so that the first template used in the prediction process is applicable to the current block, and the interference of the unreasonable result can be reduced.

The embodiments of the present disclosure provide a decoding method. When a prediction mode corresponding to a current block is a preset prediction mode, a first template corresponding to the current block is determined from at least one candidate template according to size information of the current block. The preset prediction mode includes a template-based prediction mode. A prediction value corresponding to the current block is determined according to the first template. It can be seen that in the embodiments of the present disclosure, when the preset prediction mode, which is a template-based prediction mode, is used for prediction processing on the current block, the at least one candidate template may be determined according to the size information of the current block. The use of candidate templates that do not conform to the size information of the current block is restricted to obtain the first template used in the subsequent prediction processing. Since the first template is obtained based on the size information of the current block, during the prediction processing by using the template-based prediction mode, the first template can be suitable for the scenario corresponding to the current block, which can reduce unnecessary overhead or interference caused by unreasonable results, thereby improving the compression efficiency and the encoding and decoding performance.

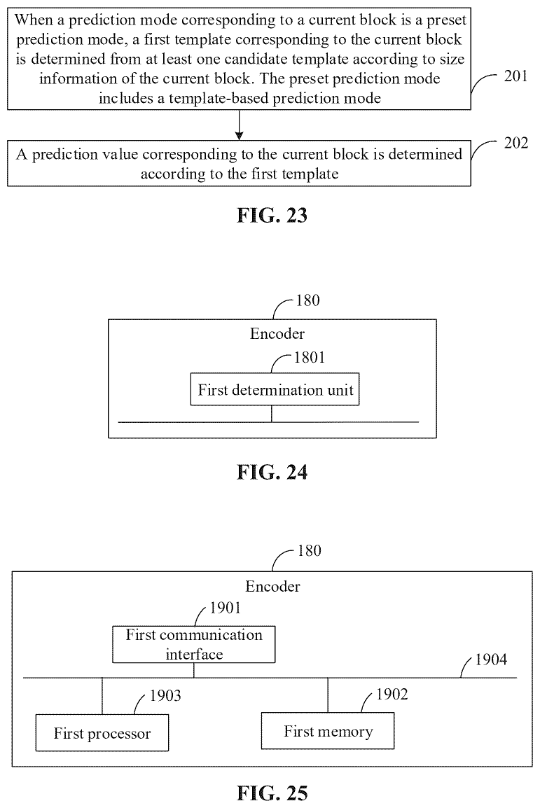

The embodiment of the present disclosure proposes an encoding method. The encoding method is applied to an encoder. FIG. 23 is a flowchart of the encoding method according to an embodiment of the present disclosure. As illustrated in FIG. 23, a method in which the encoder performs the encoding processing may include the following operations.

In operation 201, when a prediction mode corresponding to a current block is a preset prediction mode, a first template corresponding to the current block is determined from at least one candidate template according to size information of the current block. The preset prediction mode includes a template-based prediction mode.

In the embodiments of the present disclosure, the first template corresponding to the current block may be first determined. When the prediction mode corresponding to the current block is a preset prediction mode, the first template corresponding to the current block may be determined from at least one candidate template according to the size information of the current block.

It should be noted that the encoding method according to the embodiment of the present disclosure is applied to an encoder. Further, the encoding method may include an intra prediction method, more specifically, a colour component prediction method. Here, the video picture may be partitioned into multiple coding blocks, and each coding block may include a first colour component, a second colour component, and a third colour component. The current block in the embodiments of the present disclosure refers to a coding block currently to be intra-predicted in the video picture.

Here, when it is necessary to predict the first colour component, the component to be predicted is the first colour component. When it is necessary to predict the second colour component, the component to be predicted is the second colour component. When it is necessary to predict the third colour component, the component to be predicted is the third colour component. In addition, assuming that the first colour component of the current block is predicted and the first colour component is a luma component (i.e., the component to be predicted is a luma component), the current block may also be referred to as a luma block. Alternatively, assuming that the second colour component of the current block is predicted and the second colour component is a chroma component (i.e., the component to be predicted is a chroma component), the current block may also be referred to as a chroma block.

It should be noted that, in the embodiments of the present disclosure, the first template corresponding to the current block may be a candidate template in a template set corresponding to the current block. The candidate templates corresponding to the current block include multiple candidate templates of different template types.

It may be understood that, in the embodiments of the present disclosure, a template set corresponding to the current block may be first constructed based on different template types, and then the first template corresponding to the current block may be determined from candidate templates in the template set.

Exemplarily, in the embodiments of the present disclosure, as illustrated in FIG. 21, when the above-left reference sample, the above reference sample, and the left reference sample are all available, the template shape is as illustrated in (a). When only the left reference sample is available, the template shape is illustrated in (b). When only the above reference sample is available, the template shape is illustrated in (c). When only the left reference sample and the above-left reference sample are available, the template shape is illustrated in (d). When only the left reference sample and the bottom-left reference sample are available, the template shape is as illustrated in (c). When only the above reference sample and the above-right reference sample are available, the template shape is illustrated in (f).

Further, in the embodiments of the present disclosure, when constructing the template set corresponding to the current block according to the template types, the template reference sample(s) of the current block may be first determined according to the template type and the template size corresponding to the template type. Then the candidate templates of the current block may be determined according to the template reference sample(s). Finally, the construction of the template set may be completed.

It should be noted that, in the embodiments of the present disclosure, the first candidate template in the template set may be a template that includes the left neighbouring reconstructed sample and the above neighbouring reconstructed sample of the current block, such as the TL template. The second candidate template in the template set may be a template that includes the above neighbouring reconstructed sample of the current block, such as the T template. The third candidate template in the template set may be a template that includes the left neighbouring reconstructed sample of the current block, such as the L template.

That is, in the embodiments of the present disclosure, the at least one candidate template corresponding to the current block may include the TL template, the T template, and the L template.

Exemplarily, in the embodiments of the present disclosure, as illustrated in FIG. 22, corresponding to four different template types, the finally generated candidate templates of the current block may also include four types, such as the candidate template 1 (TL template), the candidate template 2 (TL template), the candidate template 3 (T template), and the candidate template 4 (L template).

Exemplarily, in some embodiments, the first template corresponding to the current block may be the first candidate template in the template set corresponding to the current block, such as the candidate template 1.

Exemplarily, in some embodiments, the first template corresponding to the current block may be the second candidate template in the template set corresponding to the current block, such as the candidate template 3.

Exemplarily, in some embodiments, the first template corresponding to the current block may be the third candidate template in the template set corresponding to the current block, such as the candidate template 4.

Further, in the embodiments of the present disclosure, the preset prediction mode may include the template-based prediction mode. That is, in the present disclosure, the prediction manner involving the use of the template in the prediction processing may be uniformly determined as the preset prediction mode.

Exemplarily, in some embodiments, the preset prediction mode may include any one of the template-based prediction modes such as the Intra TMP, the IBC, the Inter Template Matching Prediction, the TIMD, or the DIMD.

It may be understood that in the embodiments of the present disclosure, for the intraTMP, the best matching block found through the template matching is finally taken as the determined prediction block. That is, the intraTMP may be a template-based prediction mode, and thus the intraTMP may be used as the preset prediction mode.

It may be understood that in the embodiments of the present disclosure, for the template matching of the IBC, the best matching block of the current block is determined through the template matching method within the search range. That is, the template matching of the IBC may be a template-based prediction mode, and thus the template matching of the IBC may be used as the preset prediction mode.

It may be understood that in the embodiments of the present disclosure, for the Inter Template Matching Prediction, the best matching block of the current block is determined through the template matching method within the reference frame. That is, the Inter Template Matching Prediction may be the template-based prediction mode, and thus the Inter Template Matching Prediction may be used as the preset prediction mode.

It may be understood that in the embodiments of the present disclosure, for the TIMD, some candidate intra prediction modes are used for prediction on the templates, and one or two intra prediction modes with the lowest cost are selected as the intra prediction values of the current block. That is, the TIMD may be the template-based prediction mode, and thus the TIMD may be used as the preset prediction mode.

It may be understood that in the embodiments of the present disclosure, the process of the DIMD is similar to that of the TIMD. Although the prediction on the template is not performed for the DIMD, the regions of the templates are used. Therefore, the DIMD may be the template-based prediction mode, and the DIMD may be used as the preset prediction mode.

It may be understood that in the embodiments of the present disclosure, other template-based prediction modes except the Intra Template Matching Prediction, the IBC, the Inter Template Matching Prediction, the TIMD and the DIMD may be used as the preset prediction mode, which is not specifically limited in the present disclosure.

It may be understood that in the embodiments of the present disclosure, when it is determined that the prediction mode corresponding to the current block is the preset prediction mode, the size information of the current block may be used to select and restrict the candidate template. Specifically, the first template corresponding to the current block may be determined from at least one candidate template according to the size information corresponding to the current block.

It should be noted that in the embodiments of the present disclosure, the first template is a template used when the prediction is performed on the current block based on the preset prediction mode.

It should be noted that in the embodiments of the present disclosure, the size information corresponding to the current block may include information related to the height and/or width corresponding to the current block.

Exemplarily, in some embodiments, the size information corresponding to the current block may include a height and a width of the current block, and the height and the width of the current block may be absolute values of the height and width of the current block, respectively.

Further, in the embodiments of the present disclosure, prediction mode identification information corresponding to the current block may be determined. When a value of the prediction mode identification information is a first value, it may be determined that the prediction mode corresponding to the current block is the preset prediction mode. When the value of the prediction mode identification information is a second value, it may be determined that the prediction mode corresponding to the current block is not the preset prediction mode.

It may be understood that in the embodiments of the present disclosure, the prediction mode identification information may be used to determine whether the template-based prediction mode is used for the current block (i.e., whether the prediction mode of the current block is the preset prediction mode), and further, whether prediction is performed on the current block by using the preset prediction mode is determined through the prediction mode identification information.

Exemplarily, in some embodiments, a variable used as the prediction mode identification information is determined, so that the prediction mode identification information can be determined through the value of the variable.

It should be noted that in the present disclosure, the value of the prediction mode identification information may be the first value or the second value. The manner to determine the prediction value of the current block varies with different values of the prediction mode identification information. Specifically, based on the value of the prediction mode identification information, when determining the prediction value of the current block, using the preset prediction mode may be selected, or not using the preset prediction mode may be selected.

Exemplarily, in some embodiments, assuming that the preset prediction mode is the Intra TMP, the prediction mode identification information may be understood as a flag bit indicating whether the intra TMP is used. When the value of the prediction mode identification information is the first value, the prediction value of the current block may be determined by using the intra TMP. When the value of the prediction mode identification information is the second value, the prediction value of the current block may be determined without using the intra TMP.

Exemplarily, in some embodiments, the first value may be set to be 1 and the second value may be set to be 0. Alternatively, the first value is set to be true and the second value is set to be false. The first value and the second value are not limited in the present disclosure.

Exemplarily, in some embodiments, assuming that the preset prediction mode is the intra TMP, the flag intra_tmp_flag may be used to represent the prediction mode identification information, that is, intra_tmp_flag is used as the flag for the intra TMP.

Exemplarily, in some embodiments, the value of intra_tmp_flag is 1, which represents that the intra TMP is used to determine the prediction value of the current block. The value of intra_tmp_flag is 0, which represents that the intra TMP is not used when determining the prediction value of the current block.

It may be understood that in the embodiments of the present disclosure, after the value of the prediction mode identification information is determined to be the first value (i.e., after it is determined based on the value of the prediction mode identification information that the prediction value of the current block is determined by using the preset prediction mode), the first template corresponding to the current block may be further determined from at least one candidate templates according to the size information corresponding to the current block.

Further, in the embodiments of the present disclosure, when the first template corresponding to the current block is determined from the at least one candidate template according to the size information of the current block, the first template indication information corresponding to the current block is determined. When the value of the first template indication information is the third value, it may be determined that the first template is the first candidate template.

It should be noted that, in the embodiments of the present disclosure, the first candidate template may be a candidate template among at least one candidate template corresponding to the current block. For example, the first candidate template may be a TL template among the at least one candidate template.

It may be understood that in the embodiments of the present disclosure, the first template indication information may be used to determine whether the first candidate template is used for the current block. That is, the first template indication information may indicate whether the first candidate template is used to perform prediction of the preset prediction mode on the current block.

Exemplarily, in some embodiments, a variable used as the first template indication information is determined, so that the first template indication information may be determined through the value of the variable.

It should be noted that in the present disclosure, the value of the first template indication information may be the third value or the fourth value. Specifically, based on the value of the first template indication information, when performing the preset prediction mode, the first candidate template may be chosen to be used, or one may choose not to use the first candidate template and use other templates instead, such as other templates from the at least one candidate template that are not the first candidate template.

Exemplarily, in some embodiments, the third value may be set to be 0 and the fourth value may be set to be 1. Alternatively, the third value may be set to be false and the fourth value may be set to be true. The third value and the fourth value are not limited in the present disclosure.

Exemplarily, in some embodiments, assuming that the preset prediction mode is the intra TMP, the flag intra_tmp_alternative_template_flag may be used to represent the first template indication information. For example, the value of intra_tmp_alternative_template_flag is 0, which represents that the first candidate template is determined as the first template corresponding to the current block. The value of intra_tmp_alternative_template_flag is 1, which represents that the first candidate template is not determined as the first template corresponding to the current block, and another template is selected instead as the first template corresponding to the current block.

Accordingly, in the embodiments of the present disclosure, after determining the first template indication information corresponding to the current block, when the value of the first template indication information is the fourth value, it may be determined that the first template is not the first candidate template. In this case, when the size information of the current block satisfies the preset size condition, it is necessary to further determine the second template indication information corresponding to the current block, thereby determining the first template based on the second template indication information.

That is, in the embodiments of the present disclosure, when the first template corresponding to the current block is determined from the at least one candidate template according to the size information of the current block, if the value of the first template indication information is the fourth value, and the size information of the current block satisfies the preset size condition, it is necessary to further determine the second template indication information corresponding to the current block, and determine the first template according to the second template indication information.

It may be understood that in the embodiments of the present disclosure, when it is determined not to use the first candidate template according to the first template indication information, it is necessary to further determine whether to use the candidate templates other than the first candidate template according to the size information corresponding to the current block. Specifically, when the size information corresponding to the current block satisfies the preset size condition, it is determined that the candidate templates other than the first candidate template may be used, and the second template indication information may continue to be determined, so as to determine the first template according to the second template indication information.

It should be noted that, in the embodiments of the present disclosure, the preset size condition may be used to restrict the use of the candidate template based on the size of the current block.

Further, in the embodiments of the present disclosure, when the first template is determined according to the second template indication information, if the value of the second template indication information is the fifth value, it may be determined that the first template is the second candidate template, and if the value of the second template indication information is the sixth value, it may be determined that the first template is the third candidate template.

It should be noted that, in the embodiments of the present disclosure, each of the second candidate template and the third candidate template may be a respective candidate template among at least one candidate template corresponding to the current block. For example, the second candidate template may be a T template among the at least one candidate template, and the third candidate template may be an L template among the at least one candidate template.

It may be understood that in the embodiments of the present disclosure, the second template indication information may be used to determine whether the second candidate template and/or the third candidate template is (are) used for the current block. That is, the second template indication information may indicate whether the second candidate template and/or the third candidate template is (arc) used to perform prediction of the preset prediction mode on the current block.

Exemplarily, in some embodiments, a variable used as the second template indication information may be determined, so that the second template indication information may be determined through the value of the variable.

It should be noted that in the present disclosure, the value of the second template indication information may be the fifth value or the sixth value. Specifically, based on the value of the second template indication information, when performing the preset prediction mode, the second candidate template may be chosen to be used, or the third candidate template may be chosen to be used.

Exemplarily, in some embodiments, the fifth value may be set to be 0 and the sixth value may be set to be 1. Alternatively, the fifth value may be set to be false and the sixth value may be set to be true. The fifth value and the sixth value are not limited in the present disclosure.

Exemplarily, in some embodiments, assuming that the preset prediction mode is the intra TMP, the flag intra_tmp_template_idx may be used to represent the second template indication information. For example, the value of intra_tmp_template_idx is 0, which represents that the second candidate template is determined as the first template corresponding to the current block. The value of intra_tmp_template_idx is 1, which represents that the third candidate template is determined as the first template corresponding to the current block.

Further, in the embodiments of the present disclosure, when the first template corresponding to the current block is determined from the at least one candidate template according to the size information of the current block, if the value of the first template indication information is the fourth value and the size information of the current block does not satisfy the preset size condition, the determination of the second template indication information may be skipped, and the longest side of the current block may be directly determined according to the size information of the current block. Then the first template may be determined from the at least one candidate template according to the longest side of the current block.

It may be understood that in the embodiments of the present disclosure, when it is determined according to the first template indication information that the first candidate template is not used, it is necessary to further determine according to the size information corresponding to the current block whether to use candidate templates other than the first candidate template. Specifically, when the size information corresponding to the current block does not satisfy the preset size condition, it is not necessary to determine the first template according to the second template indication information, and the first template may be directly indicated according to the longest side of the current block.

It may be understood that, in the embodiments of the present disclosure, when the width of the current block is greater than the height of the current block, a side corresponding to the width may be determined as the longest side of the current block. When the height of the current block is greater than the width of the current block, a side corresponding to the height may be determined as the longest side of the current block.

That is, in the embodiments of the present disclosure, the longest side of the current block being the side corresponding to the height can also be understood as the height of the current block being greater than the width, and the longest side of the current block being the side corresponding to the width can also be understood as the width of the current block being greater than the height.

Accordingly, in the embodiments of the present disclosure, when the value of the first template indication information is the fourth value and the size information of the current block does not satisfy the preset size condition, if the height of the current block is greater than the width of the current block (i.e., the longest side of the current block is the side corresponding to the height), it may be considered that the left neighbouring region of the current block includes more neighbouring samples than the above neighbouring region. Therefore, the L template that includes more left neighbouring samples may be determined as the first template, that is, the third candidate template (L template) that includes the left neighbouring reconstructed sample of the current block is determined as the first template.

Accordingly, in the embodiments of the present disclosure, when the value of the first template indication information is the fourth value and the size information of the current block does not satisfy the preset size condition, if the width of the current block is greater than the height of the current block (i.e., the longest side of the current block is the side corresponding to the width), it may be considered that the above neighbouring region of the current block includes more neighbouring samples than the left neighbouring region. Therefore, the T template that includes more above neighbouring samples may be determined as the first template, that is, the second candidate template (T template) that includes the above neighbouring reconstructed sample of the current block is determined as the first template.

Exemplarily, in some embodiments, assuming that the height of the current block is 4 and the width of the current block is 1, it can be determined that the longest side of the current block is the side corresponding to the height, and thus the L template corresponding to the longest side may be used as the first template.

Exemplarily, in some embodiments, assuming that the height of the current block is 1 and the width of the current block is 8, it is determined that the longest side of the current block is the side corresponding to the width, and thus the T template corresponding to the longest side may be used as the first template.

Further, in the embodiments of the present disclosure, when the first template corresponding to the current block is determined from the at least one candidate template according to the size information of the current block, if the size information of the current block satisfies the preset size condition, the first template indication information corresponding to the current block may be determined. When the value of the first template indication information is the third value, it may be determined that the first template is the first candidate template.

It should be noted that, in the embodiments of the present disclosure, the first candidate template may be a candidate template among at least one candidate template corresponding to the current block. For example, the first candidate template may be a TL template among the at least one candidate template.

That is, in the embodiments of the present disclosure, when the first template corresponding to the current block is determined from at least one candidate template according to the size information of the current block, whether to use the first candidate template may be first determined according to the size information corresponding to the current block. Specifically, when the size information corresponding to the current block satisfies the preset size condition, it is determined that the first candidate template can be used, and then the first template indication information may be determined.

It should be noted that, in the embodiments of the present disclosure, the preset size condition may be used to restrict the use of the candidate template based on the size of the current block.

Accordingly, in the embodiments of the present disclosure, when the first template corresponding to the current block is determined from the at least one candidate template according to the size information of the current block, if the size information of the current block does not satisfy the preset size condition, it is not necessary to determine the first template according to the first template indication information, and the first template can be directly indicated. For example, the first candidate template may be determined as the first template.

It may be understood that in the embodiments of the present disclosure, the first template indication information may be used to determine whether the first candidate template is used for the current block. That is, the first template indication information may indicate whether the first candidate template is used to perform prediction of the preset prediction mode on the current block.

Exemplarily, in some embodiments, a variable used as the first template indication information may be determined, so that the first template indication information may be determined through the value of the variable.

It should be noted that in the present disclosure, the value of the first template indication information may be the third value or the fourth value. Specifically, based on the value of the first template indication information, when performing the preset prediction mode, the first candidate template may be chosen to be used, or one may choose not to use the first candidate template and use other templates instead, such as other templates from the at least one candidate template that are not the first candidate template.

Exemplarily, in some embodiments, the third value may be set to be 0 and the fourth value may be set to be 1. Alternatively, the third value may be set to be false and the fourth value may be set to be true. The third value and the fourth value are not limited in the present disclosure.

Exemplarily, in some embodiments, assuming that the preset prediction mode is the intra TMP, the flag intra_tmp_alternative_template_flag may be used to represent the first template indication information. For example, the value of intra_tmp_alternative_template_flag is 0, which represents that the first candidate template is determined as the first template corresponding to the current block. The value of intra_tmp_alternative_template_flag is 1, which represents that the first candidate template is not determined as the first template corresponding to the current block, and another template is selected instead as the first template corresponding to the current block.

Accordingly, in the embodiments of the present disclosure, after determining the first template indication information corresponding to the current block, when the value of the first template indication information is the fourth value, it may be determined that the first template is not the first candidate template. In this case, it is necessary to further determine the second template indication information corresponding to the current block, so as to determine the first template according to the second template indication information.

Further, in the embodiments of the present disclosure, when the first template is determined according to the second template indication information, if the value of the second template indication information is the fifth value, it may be determined that the first template is the second candidate template, and if the value of the second template indication information is the sixth value, it may be determined that the first template is the third candidate template.

It should be noted that, in the embodiments of the present disclosure, each of the second candidate template and the third candidate template may be a respective candidate template among at least one candidate template corresponding to the current block. For example, the second candidate template may be a T template among the at least one candidate template, and the third candidate template may be an L template among the at least one candidate template.

It may be understood that in the embodiments of the present disclosure, the second template indication information may be used to determine whether the second candidate template and/or the third candidate template is (are) used for the current block. That is, the second template indication information may indicate whether the second candidate template and/or the third candidate template is (arc) used to perform prediction of the preset prediction mode on the current block.

Exemplarily, in some embodiments, a variable used as the second template indication information may be determined, so that the second template indication information may be determined through the value of the variable.

It should be noted that in the present disclosure, the value of the second template indication information may be the fifth value or the sixth value. Specifically, based on the value of the second template indication information, when performing the preset prediction mode, the second candidate template may be chosen to be used, or the third candidate template may be chosen to be used.

Exemplarily, in some embodiments, the fifth value may be set to be 0 and the sixth value may be set to be 1. Alternatively, the fifth value may be set to be false and the sixth value may be set to be true. The fifth value and the sixth value are not limited in the present disclosure.

Exemplarily, in some embodiments, assuming that the preset prediction mode is the intra TMP, the flag intra_tmp_template_idx may be used to represent the second template indication information. For example, the value of intra_tmp_template_idx is 0, which represents that the second candidate template is determined as the first template corresponding to the current block. The value of intra_tmp_template_idx is 1, which represents that the third candidate template is determined as the first template corresponding to the current block.

That is, in the embodiments of the present disclosure, it is possible to indicate which one of the at least one candidate template is the first template corresponding to the current block. For example, the first template is indicated by using the first template indication information and/or the second template indication information. In the process of determining the first template, it is necessary to use the size information corresponding to the current block to restrict the candidate template.

It can be understood that in the embodiments of the present disclosure, based on the preset size condition, the use of the candidate template may be restricted according to the size of the current block. Specifically, when the implications included in the size information corresponding to the current block are different, the corresponding preset size conditions may be different.

Further, in the embodiments of the present disclosure, when the size information includes a height and a width of the current block, accordingly, the preset size condition includes: the width being less than a first numerical multiple of the height and the height being less than a second numerical multiple of the width.

It may be understood that in the embodiments of the present disclosure, the first numerical multiple and the second numerical multiple may be used to restrict the ratio between the width and the height of the current block.

It should be noted that in the embodiments of the present disclosure, the first numerical multiple and the second numerical multiple may be any numerical values greater than 0, and the first numerical multiple and the second numerical multiple may be the same or different, which are not specifically limited in the present disclosure.

Exemplarily, in the embodiments of the present disclosure, the first numerical multiple may be 4, and the second numerical multiple may be 8.

Exemplarily, in the embodiments of the present disclosure, both the first numerical multiple and the second numerical multiple may be 4.

It may be understood that, in the embodiments of the present disclosure, when determining whether the size information of the current block satisfies the preset size condition, if the width of the current block is less than the first numerical multiple of the height and the height of the current block is less than the second numerical multiple of the width, it may be determined that the size information of the current block satisfies the preset size condition. Accordingly, if the width of the current block is greater than or equal to the first numerical multiple of the height, or the height of the current block is greater than or equal to the second numerical multiple of the width, it may be determined that the size information of the current block does not satisfy the preset size condition

Exemplarily, in some embodiments, assuming that the preset prediction mode is the intra TMP, taking three candidate templates (i.e., a TL template, a T template, and an L template) as an example, the first candidate template is the TL template, the second candidate template is the T template, the third candidate template is the L template, and both the first ratio threshold and the second ratio threshold are 4. The preset size condition is that the height-to-width ratio is less than the first ratio threshold and the width-to-height ratio is less than the second ratio threshold, that is, the preset size condition may be represented as width<height×4 && height<width×4. The flag intra_tmp_flag represents the prediction mode identification information. The flag intra_tmp_alternative_template_flag represents the first template indication information, and the flag intra_tmp_template_idx represents the second template indication information. Information in the bitstream is as follows:

```
intra_tmp_flag
if(intra_tmp_flag){
  intra_tmp_alternative_template_flag
  if(intra_tmp_alternative_template_flag && width<height×4 &&
  height<width×4) {
    intra_tmp_template_idx
  }
}
```

Herein, intra_tmp_flag indicates whether the intra TMP is used for the current block. When the intra TMP is used for the current block, intra_tmp_alternative_template_flag is determined, and intra_tmp_alternative_template_flag indicates whether another template is used for the current block. When the value of intra_tmp_alternative_template_flag is 0, the TL template is used for the current block. When the value of intra_tmp_alternative_template_flag is 1 and the current block satisfies the conditions that the width is less than four times the height and the height is less than four times the width (i.e., the height and width satisfy the conditions of width<height×4 and height<width×4), the intra_tmp_template_idx is determined, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

Accordingly, in the embodiments of the present disclosure, when the height and the width of the current block do not satisfy the conditions of width<height×4 and height<width×4, the candidate template corresponding to the longest side may be selected by default. For example, when the longest side is the side corresponding to the height, the L template is selected, and when the longest side is the side corresponding to the width, the T template is selected.

Exemplarily, in some embodiments, assuming that the preset prediction mode is the intra TMP, taking three candidate templates (i.e., a TL template, a T template, and an L template) as an example, the first candidate template is the TL template, the second candidate template is the T template, the third candidate template is the L template, and both the first ratio threshold and the second ratio threshold are 4. The preset size condition is that the height-to-width ratio is less than the first ratio threshold and the width-to-height ratio is less than the second ratio threshold, that is, the preset size condition may be represented as width<height×4 && height<width×4. The flag intra_tmp_flag represents the prediction mode identification information. The flag intra_tmp_alternative_template_flag represents the first template indication information, and the flag intra_tmp_template_idx represents the second template indication information. Information in the bitstream is as follows:

```
intra_tmp_flag
if(intra_tmp_flag){
  if(width<height×4 && height<width×4){
    intra_tmp_alternative_template_flag
    if(intra_tmp_alternative_template_flag) {
      intra_tmp_template_idx
    }
  }
}
```

Herein, intra_tmp_flag indicates whether the intra TMP is used for the current block. When the intra TMP is used for the current block, it is necessary to first determine whether the current block satisfies the conditions that the width is less than four times the height and the height is less than four times the width (i.e., whether the height and the width satisfy the conditions of width<height×4 and height<width×4). If the conditions are not satisfied, the parsing of intra_tmp_alternative_template_flag is skipped, and the TL template is directly selected by default. If the conditions are satisfied, intra_tmp_alternative_template_flag is determined, and intra_tmp_alternative_template_flag indicates whether another template is used for the current block. When the value of intra_tmp_alternative_template_flag is 0, it is represented that the TL template is used for the current block. When the value of intra_tmp_alternative_template_flag is 1, intra_tmp_template_idx is determined, and intra_tmp_template_idx indicates whether the T template or the L template is used for the current block. For example, a value of intra_tmp_template_idx being 0 represents that the T template is used for the current block, and a value of intra_tmp_template_idx being 1 represents that L template is used for the current block.

Further, in the embodiments of the present disclosure, when the size information includes a height and a width of the current block, accordingly, the preset size condition includes: the height being greater than the first size threshold and the width being greater than the second size threshold.

It may be understood that in the embodiments of the present disclosure, the first size threshold may be used to restrict the height (an absolute value of height) of the current block, and accordingly, the second size threshold may be used to restrict the width (an absolute value of the width) of the current block.

It should be noted that in the embodiments of the present disclosure, the first size threshold and the second size threshold may be any numerical values greater than 0, and the first size threshold and the second size threshold may be the same or different, which are not specifically limited in the present disclosure.

Exemplarily, in the embodiments of the present disclosure, the first size threshold may be 8, and the second size threshold may be 4.

Exemplarily, in the embodiments of the present disclosure, the first size threshold and the second size threshold may both be 8.

It may be understood that, in the embodiments of the present disclosure, when determining whether the size information of the current block satisfies the preset size condition, if the height of the current block is greater than the first size threshold and the width of the current block is greater than the second size threshold, it may be determined that the size information of the current block satisfies the preset size condition. Accordingly, if the height of the current block is less than or equal to the first size threshold, or the width of the current block is less than or equal to the second size threshold, it may be determined that the size information of the current block does not satisfy the preset size condition.

Exemplarily, in some embodiments, assuming that the preset prediction mode is the intra TMP, taking three candidate templates (i.e., a TL template, a T template, and an L template) as an example, the first candidate template is the TL template, the second candidate template is the T template, the third candidate template is the L template, and the first size threshold and the second size threshold are both 4. The preset size condition is that the height is greater than the first size threshold and the width is greater than the second size threshold, that is, the preset size condition may be represented as width>4&&height>4. The flag intra_tmp_flag represents the prediction mode identification information, the flag intra_tmp_alternative_template_flag represents the first template indication information, and the flag intra_tmp_template_idx represents the second template indication information. Information in the bitstream is as follows:

```
intra_tmp_flag
if(intra_tmp_flag){
  intra_tmp_alternative_template_flag
  if(intra_tmp_alternative_template_flag && width>4 && height>4) {
    intra_tmp_template_idx
  }
}
```

Herein, intra_tmp_flag indicates whether the intra TMP is used for the current block. When the intra TMP is used for the current block, intra_tmp_alternative_template_flag is determined, and intra_tmp_alternative_template_flag indicates whether another template is used for the current block. When the value of intra_tmp_alternative_template_flag is 0, the TL template is used for the current block. When the value of intra_tmp_alternative_template_flag is 1 and the width and height of the current block satisfy the conditions of width>4 and height>4, intra_tmp_template_idx is determined, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

Accordingly, in the embodiments of the present disclosure, when the width and the height of the current block do not satisfy the conditions of width>4 and height>4, the candidate template corresponding to the longest side may be selected by default. For example, when the longest side is the side corresponding to the height, the L template is selected, and when the longest side is the side corresponding to the width, the T template is selected.

Exemplarily, in some embodiments, assuming that the preset prediction mode is the intra TMP, taking three candidate templates (i.e., a TL template, a T template, and an L template) as an example, the first candidate template is the TL template, the second candidate template is the T template, the third candidate template is the L template, and the first size threshold and the second size threshold are both 4. The preset size condition is that the height is greater than the first size threshold and the width is greater than the second size threshold, that is, the preset size condition may be represented as width>4&&height>4. The flag intra_tmp_flag represents the prediction mode identification information, the flag intra_tmp_alternative_template_flag represents the first template indication information, and the flag intra_tmp_template_idx represents the second template indication information. Information in the bitstream is as follows:

```
intra_tmp_flag
if(intra_tmp_flag){
  if(width>4 && height>4){
    intra_tmp_alternative_template_flag
    if(intra_tmp_alternative_template_flag) {
      intra_tmp_template_idx
    }
  }
}
```

Herein, intra_tmp_flag indicates whether the intra TMP is used for the current block. When the intra TMP is used for the current block, it is necessary to first determine whether the width and height of the current block satisfy the conditions of width>4 and height>4. If the conditions are not satisfied, the parsing of intra_tmp_alternative_template_flag is skipped, and the TL template is directly selected by default. If satisfied, intra_tmp_alternative_template_flag is determined, and intra_tmp_alternative_template_flag indicates whether another template is used for the current block. When the value of intra_tmp_alternative_template_flag is 0, the TL template is used for the current block. When the value of intra_tmp_alternative_template_flag is 1, intra_tmp_template_idx is determined, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

Further, in the embodiments of the present disclosure, when the size information includes a height and a width of the current block, accordingly, the preset size condition include: the width being less than the first numerical multiple of the height and the height being less than the second numerical multiple of the width, and the height being greater than the first size threshold and the width being greater than the second size threshold.

It may be understood that in the embodiments of the present disclosure, the first numerical multiple and the second numerical multiple may be used to restrict the ratio between the width and the height of the current block. The first size threshold may be used to restrict the height (an absolute value of height) of the current block, and the second size threshold may be used to restrict the width (an absolute value of the width) of the current block.

It should be noted that in the embodiments of the present disclosure, the first numerical multiple and the second numerical multiple may be any numerical values greater than 0, and the first numerical multiple and the second numerical multiple may be the same or different, which are not specifically limited in the present disclosure.

It should be noted that in the embodiments of the present disclosure, the first size threshold and the second size threshold may be any numerical values greater than 0, and the first size threshold and the second size threshold may be the same or different, which are not specifically limited in the present disclosure.

Exemplarily, in the embodiments of the present disclosure, the first numerical multiple and the second numerical multiple may both be 4, and the first size threshold and the second size threshold may both be 8.

It may be understood that in the embodiments of the present disclosure, when determining whether the size information of the current block satisfies the preset size condition, if the width of the current block is less than the first numerical multiple of the height and the height of the current block is less than the second numerical multiple of the width, and the height of the current block is greater than the first size threshold and the width of the current block is greater than the second size threshold, it may be determined that the size information of the current block satisfies the preset size condition. Accordingly, when the width of the current block is greater than or equal to the first numerical multiple of the height, or the height of the current block is greater than or equal to the second numerical multiple of the width, or the height of the current block is less than or equal to the first size threshold, or the width of the current block is less than or equal to the second size threshold, it may be determined that the size information of the current block does not satisfy the preset size condition.

Exemplarily, in some embodiments, assuming that the preset prediction mode is the intra TMP, taking three candidate templates (i.e., a TL template, a T template, and an L template) as an example, the first candidate template is the TL template, the second candidate template is the T template, the third candidate template is the L template, the first ratio threshold and the second ratio threshold are both 4, and the first size threshold and the second size threshold are both 4. The preset size condition is that the height-to-width ratio is less than the first ratio threshold and the width-to-height ratio is less than the second ratio threshold, and the height is greater than the first size threshold and the width is greater than the second size threshold. That is, the preset size condition may be represented as width<height×4&&height<width×4&&width>4&&height>4). The flag intra_tmp_flag represents the prediction mode identification information, the flag intra_tmp_alternative_template_flag represents the first template indication information, and the flag intra_tmp_template_idx represents the second template indication information. Information in the bitstream is as follows:

```
intra_tmp_flag
if(intra_tmp_flag){
  intra_tmp_alternative_template_flag
  if(intra_tmp_alternative_template_flag && width<height×4 &&
      height<width×4 && width>4 && height>4) {
      intra_tmp_template_idx
    }
}
```

Herein, intra_tmp_flag indicates whether the intra TMP is used for the current block. When the intra TMP is used for the current block, intra_tmp_alternative_template_flag is determined, and intra_tmp_alternative_template_flag indicates whether another template is used for the current block. When the value of intra_tmp_alternative_template_flag is 0, the TL template is used for the current block. When the value of intra_tmp_alternative_template_flag is 1, when the current block satisfies the conditions that the width is less than four times the height and the height is less than four times the width (i.e., the height and width satisfy the conditions of width<height×4 and height<width×4), and when the height and the width satisfy the conditions of width>4 and height>4, intra_tmp_template_idx is determined, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

Accordingly, in the embodiments of the present disclosure, when the height and the width of the current block do not satisfy the conditions of width<height×4, height<width×4, width>4 and height>4, the candidate template corresponding to the longest side may be selected by default. For example, when the longest side is the side corresponding to the height, the L template is selected, and when the longest side is the side corresponding to the width, the T template is selected.

Exemplarily, in some embodiments, assuming that the preset prediction mode is the intra TMP, taking three candidate templates (i.e., a TL template, a T template, and an L template) as an example, the first candidate template is the TL template, the second candidate template is the T template, the third candidate template is the L template, the first ratio threshold and the second ratio threshold are both 4, and the first size threshold and the second size threshold are both 4. The preset size condition is that the height-to-width ratio is less than the first ratio threshold and the width-to-height ratio is less than the second ratio threshold, and the height is greater than the first size threshold and the width is greater than the second size threshold. That is, the preset condition may be represented as width<height×4&&height<width×4&&width>4&&height>4). The flag intra_tmp_flag represents the prediction mode identification information, the flag intra_tmp_alternative_template_flag represents the first template indication information, and the flag intra_tmp_template_idx represents the second template indication information. Information in the bitstream is as follows:

```
intra_tmp_flag
if(intra_tmp_flag){
  if(width<height×4 && height<width×4&& width>4 && height>4){
      intra_tmp_alternative_template_flag
      if(intra_tmp_alternative_template_flag) {
        intra_tmp_template_idx
      }
    }
}
```

Herein, intra_tmp_flag indicates whether the intra TMP is used for the current block. When the intra TMP is used for the current block, it is necessary to first determine whether the current block satisfies the conditions that the width is less than four times the height and the height is less than four times the width, (i.e., whether the width and height satisfy the conditions of width<height×4 and height<width×4), and determine whether the height and width of the current block satisfy the conditions of width>4 and height>4. If the conditions are not satisfied, the parsing of intra_tmp_alternative_template_flag is skipped, and the TL template is directly selected by default. If the conditions are satisfied, intra_tmp_alternative_template_flag is determined, and intra_tmp_alternative_template_flag indicates whether another template is used for the current block. When the value of intra_tmp_alternative_template_flag is 0, the TL template is used for the current block. When the value of intra_tmp_alternative_template_flag is 1, intra_tmp_template_idx is determined, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

It may be understood that in the above examples of the embodiments of the present disclosure, different candidate templates are selected in an explicit manner, that is, information for selecting different templates needs to be signalled into the bitstream. The unnecessary overhead can be reduced by the method of restricting the candidate templates through the size information of the current block.

Further, in the embodiments of the present disclosure, some template-based prediction technologies (e.g., TIMD, DIMD, etc.) may derive an intra prediction mode according to the TL template, the T template, and the L template, respectively. In order not to increase additional overhead, different processing can be performed based on the analysis of the threshold condition.

It may be understood that in the embodiments of the present disclosure, the DIMD uses the gradients of the reconstructed samples neighbouring the current block to construct a histogram of the intra prediction modes. The two intra prediction modes with the highest values in the histogram are selected and denoted as mode0 and model. Together with the planar mode, the prediction values of the three intra prediction modes (i.e., mode0, model and the planar mode) are weighted.

It should be noted that, in the embodiments of the present disclosure, when implementing a position-related weight derivation method in the DIMD, a histogram for a T template, which is denoted as H_T, and a histogram for an L template, which is denoted as H_L, may be respectively constructed when constructing a histogram for a TL template. For X being 0 or 1, when H_T [modeX]>H_L [modeX]×2, modeX mainly depends on the T template, and modeX has a greater weight at the position closer to the above side. Otherwise, when H_L [modeX]>H_T [modeX]×2, modeX mainly depends on the L template, and modeX has a greater weight at the position closer to the left side. Otherwise, for the modeX, position-related weights are not used.

It may be understood that in the above position-related weight derivation method of the DIMD, whether the position-related weights are used is determined according to the data, and information such as a flag bit is not added. In this case, the size information may also be applied to restrict the weight derivation method. For example, when the block size satisfies a condition (e.g., the conditions of width<height×4 && height<width×4 or width>4 && height>4) are satisfied, the process may be performed according to the position-related weight derivation method of the DIMD. Otherwise, the process may be performed directly according to the method in which the position-related weights are not used.

In operation 202, a prediction value corresponding to the current block is determined according to the first template.

In the embodiments of the present disclosure, when the prediction mode corresponding to the current block is a preset prediction mode, after the first template corresponding to the current block is determined from the at least one candidate template according to the size information of the current block (i.e., after the first template corresponding to the current block is determined), the prediction value corresponding to the current block may be further determined according to the first template.

It should be noted that, in the embodiments of the present disclosure, in the process of performing prediction processing on the current block by using the preset prediction mode, the prediction processing process based on the template for the current block may be completed by using the determined first template (i.e., the prediction block corresponding to the current block may be obtained by using the first template), and then the prediction value corresponding to the current block may be determined.

Further, in the embodiments of the present disclosure, when the prediction value corresponding to the current block is determined according to the first template, the best matching block corresponding to the current block may be first determined based on the first template. Then the prediction value corresponding to the current block is determined according to the best matching block. For example, the reconstructed value corresponding to the best matching block may be determined as the prediction value of the current block.

It may be understood that in the embodiments of the present disclosure, after the first template of the current block is determined, the best matching block corresponding to the current block may be searched by using the first template, and finally the prediction value of the current block may be determined according to the obtained best matching block. For example, the best matching block is used as the prediction block of the current block, and the prediction value corresponding to the current block is further determined. The above method for determining the prediction value of the current block based on the first template may be applied to a case that the preset prediction mode is the intraTMP.

It may be understood that in the embodiments of the present disclosure, after the first template of the current block is determined, the best matching block corresponding to the current block may be searched by using the first template, and finally the prediction value of the current block may be determined according to the obtained best matching block. For example, the best matching block of the current block is determined within the search range by using the first template, and then the best matching block is used as the prediction block of the current block to determine the prediction value corresponding to the current block. The above method for determining the prediction value of the current block based on the first template may be applied to a case that the preset prediction mode is template matching of the IBC.

It may be understood that in the embodiments of the present disclosure, after the first template of the current block is determined, the best matching block corresponding to the current block may be searched by using the first template, and finally the prediction value of the current block may be determined according to the obtained best matching block. For example, the first template may be used to determine the best matching block of the current block by a template matching method in a reference frame, and then the best matching block may be used as the prediction block of the current block to determine the prediction value corresponding to the current block. The above method for determining the prediction value of the current block based on the first template may be applied to a case that the preset prediction mode is the inter template matching prediction.

It may be understood that in the embodiments of the present disclosure, after the first template of the current block is determined, the best matching block corresponding to the current block may be searched by using the first template, and finally the prediction value of the current block may be determined according to the obtained best matching block. For example, prediction may be performed on the first template by using some candidate intra prediction modes, and one or two intra prediction modes with the lowest cost may be used as intra prediction value(s) of the current block. Then the prediction value corresponding to the current block is determined. The above method for determining the prediction value of the current block based on the first template may be applied to a case that the preset prediction mode is the TIMD.

It may be understood that in the embodiments of the present disclosure, after the first template of the current block is determined, the best matching block corresponding to the current block may be searched by using the first template, and finally the prediction value of the current block may be determined according to the obtained best matching block. For example, the region of the first template may be used to determine one or two intra prediction modes with the lowest costs as the intra prediction value(s) of the current block, and then the prediction value corresponding to the current block may be determined. The above method for determining the prediction value of the current block based on the first template may be applied to a case that the preset prediction mode is the DIMD.

Further, in the embodiments of the present disclosure, after the prediction value of the current block is determined according to the first template corresponding to the current block, the reconstructed value of the current block may be further determined according to the prediction value of the current block.

It should be noted that in the embodiments of the present disclosure, the prediction residual corresponding to the current block needs to be first determined, and then the reconstructed value of the current block may be further determined according to the prediction residual and the prediction value.

It may be understood that, in the embodiments of the present disclosure, after determining the prediction residual of the current block according to the prediction value of the current block, the prediction residual may be signalled into the bitstream. Thus, the decoder can determine the prediction residual corresponding to the current block by decoding the bitstream, and further determine the reconstructed value of the current block according to the prediction residual and the prediction value.

In summary, through the encoding method proposed in the operations 201 to 202, in the process of performing prediction processing on the current block by using the template-based prediction technology, the candidate templates may be screened and restricted by using the size information of the current block, thereby determining the first template for performing the prediction processing. In the process of screening and restricting the candidate templates, candidate templates that are not applicable to the current block may be eliminated based on the size information of the current block, thereby reducing unnecessary overhead or reducing interference caused by unreasonable results.

That is, according to the encoding and decoding methods proposed in the embodiments of the present disclosure, with respect to the problem that the derived result may be unreasonable when the ratio of a template is too small or the template size is too small, the candidate template can be restricted through the size information corresponding to the current block, so that the first template used in the prediction process is applicable to the current block, and the interference of the unreasonable result can be reduced.

The embodiments of the present disclosure provide an encoding method. When a prediction mode corresponding to a current block is a preset prediction mode, a first template corresponding to the current block is determined from at least one candidate template according to size information of the current block. The preset prediction mode includes a template-based prediction mode. A prediction value corresponding to the current block is determined according to the first template. It can be seen that in the embodiments of the present disclosure, when the preset prediction mode, which is a template-based prediction mode, is used for prediction processing on the current block, the at least one candidate template may be determined according to the size information of the current block. The use of candidate templates that do not conform to the size information of the current block is restricted to obtain the first template used in the subsequent prediction processing. Since the first template is obtained based on the size information of the current block, during the prediction processing by using the template-based prediction mode, the first template can be suitable for the scenario corresponding to the current block, which can reduce unnecessary overhead or interference caused by unreasonable results, thereby improving the compression efficiency and the encoding and decoding performance.

Based on the above embodiments, another embodiment of the present disclosure proposes encoding and decoding methods, and the encoding and decoding methods are applied to a codec. According to the encoding and decoding methods, controlling and restriction can be performed on the use of the candidate template according to the size of the current block. For example, in one case, the use of the T template and/or the L template may be restricted according to the width-to-height ratio of the current block. In another case, the use of the T template and/or the L template may be restricted according to the absolute values of the size of the current block (i.e., the absolute values of the width and height, such as the height and the width).

It may be understood that common video coding technologies support square blocks and rectangular blocks. The width-to-height ratio of the square blocks is 1:1, while the width-to-height ratio of the rectangular blocks may reach 4:1 or 1:4, or even 8:1 or 1:8. Of course, the width is much different from the height. When the width of the current block is much different from the height of the current block, it may be understood that the function of the candidate template corresponding to the short side is not obvious.

Exemplarily, in some embodiments, for a block having a width of 4 and a height of 16, the function of the L template corresponding to the width is not obvious, so it may be stipulated that the L template is not used for the block with this size.

Exemplarily, in some embodiments, for a block having a width of 4 and a height of 16, the function of the L template corresponding to the width is not obvious, and it may be stipulated that only the TL template can be used for the block with this shape. This is because when the L template is small enough compared with the T template, there is little difference between the TL template and the T template.

Exemplarily, in some embodiments, taking intra TMP as an example, an example of a decoding syntax without any restriction on the T template and the L template is as follows:

```
intra_tmp_flag
if(intra_tmp_flag){
  intra_tmp_alternative_template_flag
  if(intra_tmp_alternative_template_flag) {
    intra_tmp_template_idx
  }
}
```

Here, intra_tmp_flag indicates whether the intra TMP is used for the current block. When the intra TMP is used for the current block, the decoder parses intra_tmp_alternative_template_flag, and intra_tmp_alternative_template_flag indicates whether another template is used for the current block. When the value of intra_tmp_alternative_template_flag is 0, the TL template is used for the current block. When the value of intra_tmp_alternative_template_flag is 1, the decoder parses intra_tmp_template_idx, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

It should be noted that in the embodiments of the present disclosure, taking the intra TMP as an example, when setting restrictions on the T template and the L template according to the width-to-height ratio and the height-to-width ratio (height and width) of the current block, the condition of && width<height×4 && height<width×4 may be added on the basis of the above example. Here, the ratio threshold (the first numerical multiple or the second numerical multiple) 4 may be replaced with another numerical value, for example, 2 or 8. That is, intra_tmp_template_idx needs to be parsed only when the above restriction condition for the width-to-height ratio is satisfied. Otherwise, when the value of intra_tmp_alternative_template_flag is 1, the candidate template corresponding to the longest side is selected by default.

Exemplarily, in some embodiments, taking the intra TMP as an example, an example of a decoding syntax for restricting the T template and the L template according to the width-to-height ratio of the current block is as follows:

```
intra_tmp_flag
if(intra_tmp_flag){
  intra_tmp_alternative_template_flag
  if(intra_tmp_alternative_template_flag && width<height×4 &&
  height<width×4) {
    intra_tmp_template_idx
  }
}
```

Herein, intra_tmp_flag indicates whether the intra TMP is used for the current block. When the intra TMP is used for the current block, the decoder parses intra_tmp_alternative_template_flag, and intra_tmp_alternative_template_flag indicates whether another template is used for the current block. When the value of intra_tmp_alternative_template_flag is 0, the TL template is used for the current block. When the value of intra_tmp_alternative_template_flag is 1, and the current block satisfies the conditions that the width is less than four times the height and the height is less than four times the width (i.e., the height and the width satisfy the conditions of width<height×4 and height<width×4), the decoder parses intra_tmp_template_idx, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

Accordingly, in the embodiments of the present disclosure, when the height and the width of the current block do not satisfy the conditions of width<height×4 and height<width×4, the candidate template corresponding to the longest side may be selected by default. For example, when the longest side is the side corresponding to the height, the L template is selected, and when the longest side is the side corresponding to the width, the T template is selected.

It should be noted that, in the embodiments of the present disclosure, taking the intra TMP as an example, when setting restrictions on the T template and the L template according to the width-to-height ratio of the current block, the conditions of width<height×4 && height<width×4 may be added on the basis of the above example. Here, the ratio threshold 4 may be replaced with another numerical value, for example, 2 or 8. That is, intra_tmp_alternative_template_flag needs to be parsed only when the above restriction condition for the width-to-height ratio is satisfied. Otherwise, the TL template is selected by default.

Exemplarily, in some embodiments, taking the intra TMP as an example, an example of a decoding syntax for restricting the T template and the L template according to the width-to-height ratio of the current block is as follows:

```
intra_tmp_flag
if(intra_tmp_flag){
  if(width<height×4 && height<width×4){
      intra_tmp_alternative_template_flag
      if(intra_tmp_alternative_template_flag) {
        intra_tmp_template_idx
      }
    }
}
```

Herein, intra_tmp_flag indicates whether the intra TMP is used for the current block. When the intra TMP is used for the current block, it is necessary to first determine whether the current block satisfies the conditions that the width is less than four times the height and the height is less than four times the width (i.e., whether the height and the width satisfy the conditions of width<height×4 and height<width×4). If the conditions are not satisfied, the parsing of intra_tmp_alternative_template_flag is skipped, and the TL template is directly selected by default. If the conditions are satisfied, the decoder parses intra_tmp_alternative_template_flag, and intra_tmp_alternative_template_flag indicates whether another template is used for the current block. When the value of intra_tmp_alternative_template_flag is 0, the TL template is used for the current block. When the value of intra_tmp_alternative_template_flag is 1, the decoder parses intra_tmp_template_idx, which indicates whether the T template or the L template is used for the current block. For example, a value of intra_tmp_template_idx being 0 represents that the T template is used for the current block, and a value of intra_tmp_template_idx being 1 represents that the L template is used for the current block.

It may be understood that, in the embodiments of the present disclosure, the absolute values of the size of the current block (i.e., the absolute values of the width and height of the current block) may also be taken as a factor to be considered.

Exemplarily, in some embodiments, the corresponding T template or L template may be used only when the absolute value(s) of the width and/or height of the current block is (are) greater than or equal to a size threshold.

It should be noted that, in the embodiments of the present disclosure, taking the intra TMP as an example, when setting restrictions on the T template and the L template according to the absolute values of the size of the current block, the conditions of width>4 && height>4 may be added on the basis of the above example. Here, the size threshold 4 may be replaced by another numerical value, for example 2 or 8. That is, intra_tmp_template_idx needs to be parsed only when the above restriction condition for the size is satisfied. Otherwise, when the value of intra_tmp_alternative_template_flag is 1, the candidate template corresponding to the longest side is selected by default.

Exemplarily, in some embodiments, taking the intra TMP as an example, an example of a decoding syntax for restricting the T template and the L template according to the absolute value(s) of the width and/or height of the current block is as follows:

```
intra_tmp_flag
if(intra_tmp_flag){
  intra_tmp_alternative_template_flag
  if(intra_tmp_alternative_template_flag && width>4 && height>4) {
    intra_tmp_template_idx
  }
}
```

Herein, intra_tmp_flag indicates whether the intra TMP is used for the current block. When the intra TMP is used for the current block, the decoder parses intra_tmp_alternative_template_flag, and intra_tmp_alternative_template_flag indicates whether another template is used for the current block. When the value of intra_tmp_alternative_template_flag is 0, the TL template is used for the current block. When the value of intra_tmp_alternative_template_flag is 1 and the width and height of the current block satisfy the conditions of width>4 and height>4, the decoder parses intra_tmp_template_idx, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

Accordingly, in the embodiments of the present disclosure, when the width and the height of the current block do not satisfy the conditions of width>4 and height>4, the candidate template corresponding to the longest side may be selected by default. For example, when the longest side is the side corresponding to the height, the L template is selected, and when the longest side is the side corresponding to the width, the T template is selected.

It should be noted that, in the embodiments of the present disclosure, taking the intra TMP as an example, when setting restrictions on the T template and the L template according to the absolute values of the size of the current block, the conditions of width>4 && height>4 may be added on the basis of the above example. Here, the size threshold 4 may be replaced with another numerical value, for example 2 or 8. That is, the intra_tmp_alternative_template_flag needs to be parsed only when the above restriction condition for the size is satisfied. Otherwise, the TL template is selected by default.

Exemplarily, in some embodiments, taking the intra TMP as an example, an example of a decoding syntax for restricting the T template and the L template according to the absolute value(s) of the width and/or height of the current block is as follows:

```
intra_tmp_flag
if(intra_tmp_flag){
  if(width>4 && height>4){
    intra_tmp_alternative_template_flag
    if(intra_tmp_alternative_template_flag) {
      intra_tmp_template_idx
    }
  }
}
```

Herein, intra_tmp_flag indicates whether the intra TMP is used for the current block. When the intra TMP is used for the current block, it is necessary to first determine whether the width and height of the current block satisfy the conditions of width>4 and height>4. If the conditions are not satisfied, the parsing of intra_tmp_alternative_template_flag is skipped, and the TL template is directly selected by default. If the conditions are satisfied, the decoder parses intra_tmp_alternative_template_flag, which indicates whether another template is used for the current block. When the value of intra_tmp_alternative_template_flag is 0, the TL template is used for the current block. When the value of intra_tmp_alternative_template_flag is 1, the decoder parses intra_tmp_template_idx, and intra_tmp_template_idx indicates whether the T template or the L template is used for the current block. For example, a value of intra_tmp_template_idx being 0 represents that the T template is used for the current block, and a value of intra_tmp_template_idx being 1 represents that the L template is used for the current block.

It should be understood that in the embodiments of the present disclosure, when restricting the use of the candidate template, two factors of the width-to-height ratio and the absolute values of the size may be used in combination, which is not specifically limited in the present disclosure.

It may be understood that in the above examples of the embodiments of the present disclosure, different candidate templates are selected in an explicit manner, that is, information for selecting different templates needs to be signalled into the bitstream. The unnecessary overhead can be reduced by the method of restricting the candidate templates through the size information of the current block.

Further, in the embodiments of the present disclosure, some template-based prediction technologies (e.g., TIMD, DIMD, etc.) may derive an intra prediction mode according to the TL template, the T template, and the L template, respectively. In order not to increase additional overhead, different processing can be performed based on the analysis of the threshold condition.

It may be understood that in the embodiments of the present disclosure, the DIMD uses the gradients of the reconstructed samples neighbouring the current block to construct a histogram of the intra prediction modes. The two intra prediction modes with the highest values in the histogram are selected and denoted as mode0 and model. Together with the planar mode, the prediction values of the three intra prediction modes (i.e., mode0, model and the planar mode) are weighted.

It should be noted that, in the embodiments of the present disclosure, when implementing a position-related weight derivation method in the DIMD, a histogram for a T template, which is denoted as H_T, and a histogram for an L template, which is denoted as H_L, may be respectively constructed when constructing a histogram for a TL template. For X being 0 or 1, when H_T [modeX]>H_L [modeX]×2, modeX mainly depends on the T template, and modeX has a greater weight at the position closer to the above side. Otherwise, when H_L [modeX]>H_T [modeX]×2, modeX mainly depends on the L template, and modeX has a greater weight at the position closer to the left side. Otherwise, for the modeX, position-related weights are not used.

It may be understood that in the above position-related weight derivation method of the DIMD, whether the position-related weights are used is determined according to the data, and information such as a flag bit is not added. In this case, the size information may also be applied to restrict the weight derivation method. For example, when the block size satisfies a condition (e.g., the conditions of width<height×4 && height<width×4 or width>4 && height>4) are satisfied, the process may be performed according to the position-related weight derivation method of the DIMD. Otherwise, the process may be performed directly according to the method in which the position-related weights are not used.

In summary, according to the encoding and decoding methods proposed in the embodiments of the present disclosure, in the process of performing prediction processing on the current block by using the template-based prediction technology, the candidate templates may be screened and restricted by using the size information of the current block, thereby determining the first template for performing the prediction processing. In the process of screening and restricting the candidate templates, candidate templates that are not applicable to the current block may be eliminated based on the size information of the current block, thereby reducing unnecessary overhead or reducing interference caused by unreasonable results.

That is, according to the encoding and decoding methods proposed in the embodiments of the present disclosure, with respect to the problem that the derived result may be unreasonable when the ratio of a template is too small or the template size is too small, the candidate template can be restricted through the size information corresponding to the current block, so that the first template used in the prediction process is applicable to the current block, and the interference of the unreasonable result can be reduced.

The embodiments of the present disclosure provide encoding and decoding methods. When a prediction mode corresponding to a current block is a preset prediction mode, a first template corresponding to the current block is determined from at least one candidate template according to size information of the current block. The preset prediction mode includes a template-based prediction mode. A prediction value corresponding to the current block is determined according to the first template. It can be seen that in the embodiments of the present disclosure, when the preset prediction mode, which is a template-based prediction mode, is used for prediction processing on the current block, the at least one candidate template may be determined according to the size information of the current block. The use of candidate templates that do not conform to the size information of the current block is restricted to obtain the first template used in the subsequent prediction processing. Since the first template is obtained based on the size information of the current block, during the prediction processing by using the template-based prediction mode, the first template can be suitable for the scenario corresponding to the current block, which can reduce unnecessary overhead or interference caused by unreasonable results, thereby improving the compression efficiency and the encoding and decoding performance.

In still another embodiment of the present disclosure, FIG. 24 illustrates a structural diagram of an encoder according to an embodiment of the present disclosure. As illustrated in FIG. 24, the encoder 180 includes the first determination unit 1801.

The first determination unit 1801 is configured to determine, when a prediction mode corresponding to a current block is a preset prediction mode, a first template corresponding to the current block from at least one candidate template according to size information of the current block, and determine a prediction value corresponding to the current block according to the first template. The preset prediction mode includes a template-based prediction mode.

It may be understood that in the embodiments of the present disclosure, the “unit” may be a part of a circuit, a part of a processor, a part of a program or software, etc. Of course, the “unit” may also be a module, or may be non-modular. Moreover, in the present embodiment, respective components may be integrated in one processing unit. Each unit may physically exist separately, or two or more units may be integrated in one unit. The above integrated unit may be implemented in the form of hardware or software functional modules.

If the integrated unit is implemented in the form of software functional modules and are not sold or used as an independent product, it may also be stored in a computer-readable storage medium. Based on such understanding, technical solutions of the embodiments of the present disclosure substantially or parts making contributions to the related art may be embodied in the form of software. The computer software product is stored in a storage medium, includes several instructions to cause a computer device (which may be a personal computer, a server, a network device, etc.) or a processor to perform all or part of the operations of the method according to the embodiments of the present disclosure. The above storage media may include: a U disk, a removable hard disk, a Read-Only Memory (ROM), a Random Access Memory (RAM), a disk or an optical disk and other media that can store program codes.

Accordingly, the embodiments of the present disclosure provide a computer-readable storage medium. The computer-readable storage medium is applied to the encoder 180, and the computer-readable storage medium is configured to stores computer program that implements the method of any one of the foregoing embodiments when executed by the first processor.

Based on the composition of the encoder 180 and the computer-readable storage medium, FIG. 25 illustrates a diagram of a specific hardware structure of the encoder 180 according to an embodiment of the present disclosure. As illustrated in FIG. 25, the encoder 180 includes a communication interface 1901, a first memory 1902, and a first processor 1903. The components are coupled together by a first bus system 1904. It may be understood that the first bus system 1904 is configured to achieve connected communication between these components. The first bus system 1904 includes a power bus, a control bus, and a status signal bus in addition to a data bus. However, for clarity of illustration, the various buses are designated as the first bus system 1904.

The first communication interface 1901 is configured to receive and transmit signals in the process of transmitting and receiving information with other external network elements.

The first memory 1902 is configured to store a computer program executable on the first processor 1903.

The first processor 1903 is configured to perform, when executing the computer program, the following processing. When a prediction mode corresponding to a current block is a preset prediction mode, a first template corresponding to the current block is determined from at least one candidate template according to size information of the current block. A prediction value corresponding to the current block is determined according to the first template. The preset prediction mode includes a template-based prediction mode.

It can be understood that the first memory 1902 in the embodiments of the present disclosure may be a volatile memory or a non-volatile memory, or may include both volatile and non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of illustrative but non-restrictive explanation, many forms of RAM are available, such as Static RAM (SRAM), Dynamic RAM (DRAM), Synchronous DRAM (SDRAM), Double Data Rate SDRAM (DDRSDRAM), Enhanced SDRAM (ESDRAM), Synchlink DRAM (SLDRAM), and Direct Rambus RAM (DRRAM). The first memory 1902 of the systems and methods described herein is intended to include, but is not limited to, these and any other suitable types of memory.

The first processor 1903 may be an integrated circuit chip having signal processing capabilities. During the implementation, the operations of the above methods may be accomplished through the integrated logic circuitry of hardware in the first processor 1903 or through the instructions in the form of software. The above first processor 1903 may be a general-purpose processor, a Digital Signal Processor (DSP), an Application Specific Integrated Circuit (ASIC), Field Programmable Gate Array (FPGA) or other programmable logic device, a discrete gate or transistor logic device, or a discrete hardware component. The methods, operations, and logical block diagrams disclosed in the embodiments of the present disclosure may be implemented or executed. The general-purpose processor may be a microprocessor or the processor may be any conventional processor or the like. The operations of the methods disclosed in connection with the embodiments of the present disclosure may be directly executed by the hardware decoding processor, or may be executed by combining hardware and software modules in the decoding processor. The software module may be located in a storage medium mature in the art, such as random access memory, flash memory, read-only memory, programmable read-only memory, or electrically erasable and writable programmable memory, registers, etc. The storage medium is located in the first memory 1902. The first processor 1903 reads the information in the first memory 1902, and completes the operations of the above method in combination with its hardware.

It should be understood that the embodiments described herein may be implemented in hardware, software, firmware, middleware, microcode, or a combination thereof. For hardware implementation, the processing unit may be implemented in one or more Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), general-purpose c processors, controllers, microcontrollers, microprocessors, other electronic units for performing the functions described herein, or combinations thereof. For software implementations, the technologies described herein may be implemented by modules (e.g., procedures, functions, etc.) that perform the functions described herein. The software code may be stored in a memory and executed by a processor. The memory may be implemented inside or outside the processor.

Alternatively, as another embodiment, the first processor 1903 is further configured to perform the method of any one of the preceding embodiments when executing the computer program.

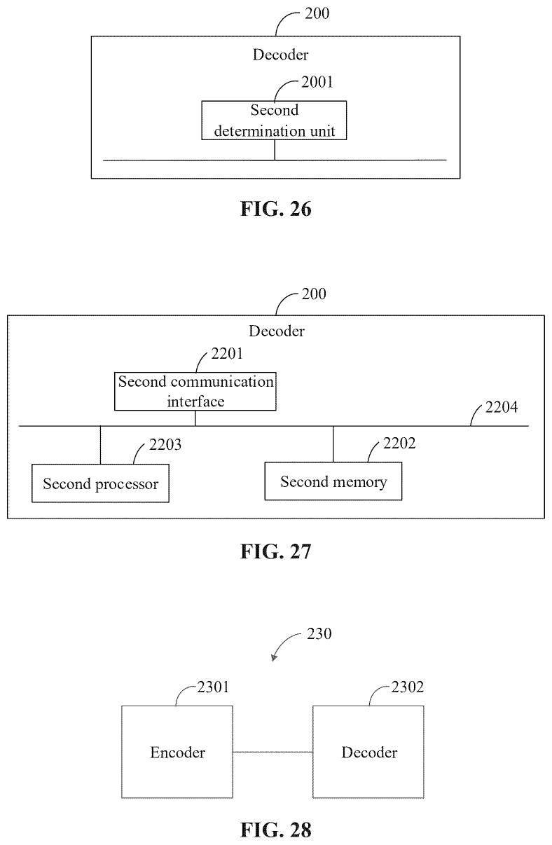

In yet another embodiment of the present disclosure, FIG. 26 illustrates a structural diagram of a decoder according to an embodiment of the present disclosure. As illustrated in FIG. 26, the decoder 200 may include a second determination unit 2001.

The second determination unit 2001 is configured to: determine, when a prediction mode corresponding to a current block is a preset prediction mode, a first template corresponding to the current block from at least one candidate template according to size information of the current block, and determine a prediction value corresponding to the current block according to the first template. The preset prediction mode includes a template-based prediction mode.

It may be understood that in the present embodiment, the “unit” may be a part of a circuit, a part of a processor, a part of a program or software, etc. Of course, the “unit” may also be a module, or may be non-modular. Moreover, in the present embodiment, the components may be integrated in one processing unit. Each unit may physically exist separately, or two or more units may be integrated in one unit. The above integrated unit may be implemented in the form of hardware or software functional modules.

The integrated unit may be stored in a computer-readable storage medium if it is implemented in the form of a software functional module and not sold or used as an independent product. Based on such understanding, the present embodiments provide a computer-readable storage medium, which is applied to the decoder 200. The computer-readable storage medium is configured to store a computer program that, when executed by the second processor, implements the method of any of the preceding embodiments.

Based on the composition of the decoder 200 and the computer-readable storage medium, FIG. 27 illustrates a diagram of a specific hardware structure of the decoder 200 according to an embodiment of the present disclosure. As illustrated in FIG. 27, the decoder 200 may include a second communication interface 2201, a second memory 2202, and a second processor 2203. The components are coupled together by a second bus system 2204. It should be understood that the second bus system 2204 is used to achieve connected communication between these components. The second bus system 2204 includes a power bus, a control bus, and a status signal bus in addition to a data bus. However, for clarity of illustration, the various buses are designated as the second bus system 2204.

The second communication interface 2201 is configured to receive and transmit signals in the process of transmitting and receiving information with other external network elements.

The second memory 2202 is configured to store a computer program executable on the second processor 2203.

The second processor 2203 is configured to perform, when executing the computer program, the following processing. When a prediction mode corresponding to a current block is a preset prediction mode, a first template corresponding to the current block is determined from at least one candidate template according to size information of the current block. A prediction value corresponding to the current block is determined according to the first template. The preset prediction mode includes a template-based prediction mode.

Alternatively, as another embodiment, the second processor 2203 is further configured to perform the method of any one of the preceding embodiments when executing the computer program.

It may be understood that the hardware functionality of the second memory 2202 is similar to that of the first memory 1902, and the hardware functionality of the second processor 2203 is similar to that of the first processor 1903, which will not be detailed here.

The embodiments of the present disclosure provide a codec. When a prediction mode corresponding to a current block is a preset prediction mode, a first template corresponding to the current block is determined from at least one candidate template according to size information of the current block. The preset prediction mode includes a template-based prediction mode. A prediction value corresponding to the current block is determined according to the first template. It can be seen that in the embodiments of the present disclosure, when the preset prediction mode, which is a template-based prediction mode, is used for prediction processing on the current block, the at least one candidate template may be determined according to the size information of the current block. The use of candidate templates that do not conform to the size information of the current block is restricted to obtain the first template used in the subsequent prediction processing. Since the first template is obtained based on the size information of the current block, during the prediction processing by using the template-based prediction mode, the first template can be suitable for the scenario corresponding to the current block, which can reduce unnecessary overhead or interference caused by unreasonable results, thereby improving the compression efficiency and the encoding and decoding performance.

In still another embodiment of the present disclosure, FIG. 28 illustrates a structural diagram of a codec system according to an embodiment of the present disclosure. As illustrated in FIG. 28, the codec system 230 may include an encoder 2301 and a decoder 2302.

In the embodiments of the present disclosure, the encoder 2301 may be the encoder described in any one of the preceding embodiments, and the decoder 2302 may be the decoder described in any one of the preceding embodiments.

Further, the embodiments of the present disclosure further provide a bitstream. The bitstream is generated by performing bit encoding on to-be-encoded information, and the to-be-encoded information includes at least one of: prediction mode identification information, first template indication information, second template indication information, or prediction residual.

It should be noted that in the present disclosure, the terms “comprising”, “including” or any other variation thereof are intended to encompass a non-exclusive inclusion such that a process, method, article, or apparatus including a series of elements includes not only those elements, but also other elements not explicitly listed, or includes elements inherent to such a process, method, article, or apparatus. In the absence of further restrictions, an element defined by the statement “including a . . . ” does not preclude the presence of additional identical elements in a process, method, article, or apparatus that includes the element.

The above serial numbers of the embodiments of the present disclosure are for description only, and do not represent the advantages and disadvantages of the embodiments.

The methods disclosed in several method embodiments provided in the present disclosure may be arbitrarily combined without conflict to obtain new method embodiments.

The features disclosed in several product embodiments provided in the present disclosure may be arbitrarily combined without conflict to obtain new product embodiments.

The features disclosed in several method or device embodiments provided in the present disclosure may be arbitrarily combined without conflict to obtain new method or device embodiments.

Embodiments of the present disclosure provide encoding and decoding methods, a bitstream, an encoder, a decoder, and a storage medium, which can reduce unnecessary overhead or interference caused by unreasonable results, thereby improving compression efficiency and improving encoding and decoding performances.

The technical solutions of the embodiments of the present disclosure can be implemented as follows.

In a first aspect, the embodiments of the present disclosure provide a decoding method. The method is applied to a decoder and includes the following operations.

When a prediction mode corresponding to a current block is a preset prediction mode, a first template corresponding to the current block is determined from at least one candidate template according to size information of the current block. The preset prediction mode includes a template-based prediction mode.

A prediction value corresponding to the current block is determined according to the first template.

In a second aspect, the embodiments of the present disclosure provide an encoding method. The method is applied to an encoder and includes the following operations.

When a prediction mode corresponding to a current block is a preset prediction mode, a first template corresponding to the current block is determined from at least one candidate template according to size information of the current block. The preset prediction mode includes a template-based prediction mode.

A prediction value corresponding to the current block is determined according to the first template.

In a third aspect, the embodiments of the present disclosure provide a bitstream. The bitstream is generated by performing bit encoding on to-be-encoded information. The to-be-encoded information includes at least one of:

Prediction mode identification information, first template indication information, second template indication information, or a prediction residual.

In a fourth aspect, the embodiments of the present disclosure provide an encoder. The encoder includes a first determination unit.

The first determination unit is configured to determine, when a prediction mode corresponding to a current block is a preset prediction mode, a first template corresponding to the current block from at least one candidate template according to size information of the current block, and determine a prediction value corresponding to the current block according to the first template. The preset prediction mode includes a template-based prediction mode.

In a fifth aspect, the embodiments of the present disclosure provide an encoder. The encoder includes a first memory and a first processor.

The first memory is configured to store a computer program executable on the first processor.

The first processor is configured to, when executing the computer program, perform the method according to the second aspect.

In a sixth aspect, the embodiments of the present disclosure provide a decoder. The decoder includes a second determination unit.

The second determination unit is configured to determine, when a prediction mode corresponding to a current block is a preset prediction mode, a first template corresponding to the current block from at least one candidate template according to size information of the current block, and determine a prediction value corresponding to the current block according to the first template. The preset prediction mode includes a template-based prediction mode.

In a seventh aspect, the embodiments of the present disclosure provide a decoder. The decoder includes a second memory and a second processor.

The second memory is configured to store a computer program executable on the second processor.

The second processor is configured to, when executing the computer program, perform the method according to the first aspect.

In an eighth aspect, the embodiments of the present disclosure provide a computer-readable storage medium. The computer-readable storage medium is configured to store a computer program that, when executed, implements the method according to the first aspect or implements the method according to the second aspect.

The embodiments of the present disclosure provide encoding and decoding methods, a bitstream, an encoder, a decoder, and a storage medium. When a prediction mode corresponding to a current block is a preset prediction mode, a first template corresponding to the current block is determined from at least one candidate template according to size information of the current block. The preset prediction mode includes a template-based prediction mode. A prediction value corresponding to the current block is determined according to the first template. It can be seen that in the embodiments of the present disclosure, when the preset prediction mode, which is a template-based prediction mode, is used for prediction processing on the current block, the at least one candidate template may be determined according to the size information of the current block. The use of candidate templates that do not conform to the size information of the current block is restricted to obtain the first template used in the subsequent prediction processing. Since the first template is obtained based on the size information of the current block, during the prediction processing by using the template-based prediction mode, the first template can be suitable for the scenario corresponding to the current block, which can reduce unnecessary overhead or interference caused by unreasonable results, thereby improving the compression efficiency and the encoding and decoding performance.

The above is merely specific embodiments of the present disclosure, but the scope of protection of the present disclosure is not limited thereto. Any person skilled in the art may easily think of changes or substitutions within the technical scope disclosed in the present disclosure, which should fall within the scope of protection of the present disclosure. Therefore, the scope of protection of the present disclosure should be based on the scope of protection of the claims.

### INDUSTRIAL PRACTICALLY

The embodiments of the present disclosure provide encoding and decoding methods, a bitstream, an encoder, a decoder, and a storage medium. When a prediction mode corresponding to a current block is a preset prediction mode, a first template corresponding to the current block is determined from at least one candidate template according to size information of the current block. The preset prediction mode includes a template-based prediction mode. A prediction value corresponding to the current block is determined according to the first template. It can be seen that in the embodiments of the present disclosure, when the preset prediction mode, which is a template-based prediction mode, is used for prediction processing on the current block, the at least one candidate template may be determined according to the size information of the current block. The use of candidate templates that do not conform to the size information of the current block is restricted to obtain the first template used in the subsequent prediction processing. Since the first template is obtained based on the size information of the current block, during the prediction processing by using the template-based prediction mode, the first template can be suitable for the scenario corresponding to the current block, which can reduce unnecessary overhead or interference caused by unreasonable results, thereby improving the compression efficiency and the encoding and decoding performance.

1. A decoding method, applied to a decoder, the method comprising:
when a prediction mode corresponding to a current block is a preset prediction mode, determining a first template corresponding to the current block from at least one candidate template according to size information of the current block, wherein the preset prediction mode comprises a template-based prediction mode; and
determining a prediction value corresponding to the current block according to the first template.

2. The method of claim 1, further comprising:
decoding a bitstream to determine prediction mode identification information corresponding to the current block;
when a value of the prediction mode identification information is a first value, determining that the prediction mode corresponding to the current block is the preset prediction mode; and
when the value of the prediction mode identification information is a second value, determining that the prediction mode corresponding to the current block is not the preset prediction mode.

3. The method of claim 1, wherein the preset prediction mode comprises any one of: Intra Template Matching Prediction (Intra TMP), Intra Block Copy (IBC), Inter Template Matching Prediction, Template Based Intra Mode Derivation (TIMD), or Decoder-side Intra Mode Derivation (DIMD).

4. The method of claim 2, wherein determining the first template corresponding to the current block from the at least one candidate template according to the size information of the current block comprises:
decoding the bitstream to determine first template indication information corresponding to the current block;
when a value of the first template indication information is a third value, determining that the first template is a first candidate template; and
when the value of the first template indication information is a fourth value, and the size information of the current block satisfies a preset size condition, decoding the bitstream to determine second template indication information corresponding to the current block, and determining the first template according to the second template indication information.

5. The method of claim 4, wherein determining the first template according to the second template indication information comprises:
when a value of the second template indication information is a fifth value, determining that the first template is a second candidate template; and
when the value of the second template indication information is a sixth value, determining that the first template is a third candidate template.

6. The method of claim 5, further comprising:
in a case that the value of the first template indication information is the fourth value and the size information of the current block does not satisfy the preset size condition, when a width of the current block is greater than a height of the current block, determining that the first template is the second candidate template; and when the height of the current block is greater than the width of the current block, determining that the first template is the third candidate template.

7. The method of claim 2, wherein determining the first template corresponding to the current block from the at least one candidate template according to the size information of the current block comprises:
when the size information of the current block satisfies a preset size condition, decoding the bitstream to determine first template indication information corresponding to the current block;
when a value of the first template indication information is a third value, determining that the first template is a first candidate template; and
when the value of the first template indication information is a fourth value, decoding the bitstream to determine second template indication information corresponding to the current block, and determining the first template according to the second template indication information.

8. The method of claim 7, wherein determining the first template according to the second template indication information comprises:
when a value of the second template indication information is a fifth value, determining that the first template is a second candidate template; and
when the value of the second template indication information is a sixth value, determining that the first template is a third candidate template.

9. The method of claim 5, wherein
the first candidate template is a template that comprises a left neighbouring reconstructed sample and an above neighbouring reconstructed sample of the current block;
the second candidate template is a template that comprises the above neighbouring reconstructed sample of the current block; and
the third candidate template is a template that comprises the left neighbouring reconstructed sample of the current block.

10. The method of claim 7, further comprising:
when the size information of the current block does not satisfy the preset size condition, determining that the first template is the first candidate template.

11. The method of claim 4, wherein the size information comprises a height and a width of the current block; and
wherein the preset size condition comprises: the width being less than a first numerical multiple of the height and the height being less than a second numerical multiple of the width; or
the preset size condition comprises: the height being greater than a first size threshold and the width being greater than a second size threshold; or
the preset size condition comprises: the width being less than the first numerical multiple of the height and the height being less than the second numerical multiple of the width, and the height being greater than the first size threshold and the width being greater than the second size threshold.

12. The method of claim 1, further comprising:
decoding a bitstream to determine a prediction residual corresponding to the current block; and
determining a reconstructed value of the current block according to the prediction residual and the prediction value.

13. The method of claim 1, wherein determining the prediction value corresponding to the current block according to the first template comprises:
determining a best matching block corresponding to the current block based on the first template; and
determining the prediction value corresponding to the current block according to the best matching block.

14. An encoding method, applied to an encoder, the method comprising:
when a prediction mode corresponding to a current block is a preset prediction mode, determining a first template corresponding to the current block from at least one candidate template according to size information of the current block, wherein the preset prediction mode comprises a template-based prediction mode; and
determining a prediction value corresponding to the current block according to the first template.

15. The method of claim 14, further comprising:
determining prediction mode identification information corresponding to the current block;
when a value of the prediction mode identification information is a first value, determining that the prediction mode corresponding to the current block is the preset prediction mode; and
when the value of the prediction mode identification information is a second value, determining that the prediction mode corresponding to the current block is not the preset prediction mode.

16. The method of claim 14, wherein the preset prediction mode comprises any one of: Intra Template Matching Prediction (Intra TMP), Intra Block Copy (IBC), Inter Template Matching Prediction, Template Based Intra Mode Derivation (TIMD), or Decoder-side Intra Mode Derivation (DIMD).

17. The method of claim 15, wherein determining the first template corresponding to the current block from the at least one candidate template according to the size information of the current block comprises:
determining first template indication information corresponding to the current block;
when a value of the first template indication information is a third value, determining that the first template is a first candidate template; and
when the value of the first template indication information is a fourth value, and the size information of the current block satisfies a preset size condition, determining second template indication information corresponding to the current block, and determining the first template according to the second template indication information.

18. The method of claim 15, wherein determining the first template corresponding to the current block from the at least one candidate template according to the size information of the current block comprises:
when the size information of the current block satisfies a preset size condition, determining first template indication information corresponding to the current block;
when a value of the first template indication information is a third value, determining that the first template is a first candidate template; and
when the value of the first template indication information is a fourth value, determining second template indication information corresponding to the current block, and determining the first template according to the second template indication information.

19. The method of claim 17, wherein the size information comprises a height and a width of the current block; and
wherein the preset size condition comprises: the width being less than a first numerical multiple of the height and the height being less than a second numerical multiple of the width; or
the preset size condition comprises: the height being greater than a first size threshold and the width being greater than a second size threshold; or
the preset size condition comprises: the width being less than the first numerical multiple of the height and the height being less than the second numerical multiple of the width, and the height being greater than the first size threshold and the width being greater than the second size threshold.

20. A non-transitory computer-readable storage medium, having a computer program and a bitstream stored thereon, wherein the computer program, when executed by a processor, enables the processor to perform operations of an encoding method to generate the bitstream,
wherein the encoding method comprises:
when a prediction mode corresponding to a current block is a preset prediction mode, determining a first template corresponding to the current block from at least one candidate template according to size information of the current block, wherein the preset prediction mode comprises a template-based prediction mode; and
determining a prediction value corresponding to the current block according to the first template.
